(19) United States
(12) Patent Application Publication
(10) Pub. No.: US 2020/0349948 A1
(43) Pub. Date: Nov. 5, 2020

(54) INFORMATION PROCESSING DEVICE, INFORMATION PROCESSING METHOD, AND PROGRAM

(71) Applicant: Sony Corporation, Tokyo (JP)

(72) Inventor: Keigo IHARA, Tokyo (JP)

(73) Assignee: Sony Corporation, Tokyo (JP)

(21) Appl. No.: 16/960,916

(22) PCT Filed: Jan. 7, 2019
(86) PCT No.: PCT/JP2019/000049

§ 371 Date: Jul. 9, 2020

(30) Foreign Application Priority Data
Jan. 16, 2018 (JP) 2018-004982

(51) Int. Cl. G10L 15/22; G10L 15/26; G10L 17/22; G10L 13/027

(52) U.S. Cl. CPC G10L 15/22; G10L 15/26; G10L 2015/223; G10L 13/027; G10L 17/22

(57) ABSTRACT

The present technology relates to an information processing device, an information processing method, and a program that allow disclosure of contents of personal information to be limited according to a person.

A privacy level for an answer is set according to a person to be answered. The privacy level for an answer includes a privacy level at a time of an answer to the person to be answered. The privacy level indicates a degree to which personal information regarding a user is disclosed. Then, an answer message that answers an utterance of the person to be answered that has been collected with a microphone is generated and output. The answer message corresponds to the privacy level for an answer. The present technology can be applied to, for example, an agent robot that answers instead of a user.

### TECHNICAL FIELD

The present technology relates to an information processing device, an information processing method, and a program, particularly to an information processing device, an information processing method, and a program that allow disclosure of contents of personal information to be limited according to a person.

### BACKGROUND ART

For example, Patent Document 1 discloses a technology that, to recommend contents and the like to a user, uses disclosed part of profile information disclosure of which is permitted according to privacy levels.

### CITATION LIST

### Patent Document

Patent Document 1: Japanese Patent Application Laid-Open No. 2009-140051

### SUMMARY OF THE INVENTION

### Problems to be Solved by the Invention

For example, when a child walks around town, there is a possibility that the child is talked by an unknown suspicious person, and encounters a crime, or personal information is heard.

In a case where the child knows the person, the child determines who the person is. However, in a case where the person is a person whom the child does not know and is familiar with, such as an acquaintance of a parent of the child, a manager of a school or a district, or the like, it is difficult for the child to determine whether or not the person is a malicious suspicious person.

On the other hand, an adult determines personal information of the adult that can be talked about according to a person, and changes a content of an answer according to the person. However, it is difficult for a child to determine personal information that can be talked about according to a person. Therefore, there is a possibility that a child talks about personal information that should not be talked about with a malicious suspicious person.

The present technology is made in such a situation, and allows disclosure of contents of personal information to be limited according to a person.

### Solutions to Problems

A signal processing device or a program of the present technology is an information processing device including an output unit that outputs an answer message obtained by: setting a privacy level for an answer according to a person to be answered, the privacy level for an answer including a privacy level at a time of an answer to the person to be answered, the privacy level indicating a degree to which personal information regarding a user is disclosed; and generating the answer message that answers an utterance of the person to be answered that has been collected with a microphone, the answer message corresponding to the privacy level for an answer, or a program that allows a computer to function as such a signal processing device.

A signal processing method of the present technology is an information processing method including: collecting a voice; and outputting an answer message obtained by: setting a privacy level for an answer according to a person to be answered, the privacy level for an answer including a privacy level at a time of an answer to the person to be answered, the privacy level indicating a degree to which personal information regarding a user is disclosed; and generating the answer message that answers an utterance of the person to be answered that has been collected with the microphone, the answer message corresponding to the privacy level for an answer.

Regarding the signal processing device, the signal processing method, and the program of the present technology, an answer message is output that is obtained by: setting a privacy level for an answer according to a person to be answered, the privacy level for an answer including a privacy level at a time of an answer to the person to be answered, the privacy level indicating a degree to which personal information regarding a user is disclosed; and generating the answer message that answers an utterance of the person to be answered that has been collected with a microphone, the answer message corresponding to the privacy level for an answer.

### Effects of the Invention

The present technology allows disclosure of contents of personal information to be limited according to a person.

Note that effects described here are not necessarily limitative, but may be any effect described in the present disclosure.

### BRIEF DESCRIPTION OF DRAWINGS

FIG. 1 is a block diagram that illustrates an example of configuration of an information processing system to which the present technology is applied.

FIG. 2 is a block diagram that illustrates an example of configuration of a server 20.

FIG. 3 is a diagram that illustrates an example of configuration of a user management database 22 in FIG. 2.

FIG. 4 is a diagram that illustrates an example of configuration of profile-data genres and profile data that are recorded in a user management table in FIG. 3.

FIG. 5 is a diagram that illustrates an example of configuration of a privacy-level management database 23 in FIG. 2.

FIG. 6 is a diagram that illustrates an example of configuration of a suspicious-person management database 24 in FIG. 2.

FIG. 7 is an outward-appearance view that schematically illustrates an example of configuration of an agent robot 30 in FIG. 1.

FIG. 8 is a diagram that illustrates an example of use of the agent robot 30 in FIG. 1.

FIG. 9 is a block diagram that illustrates an example of configuration of the agent robot 30.

FIG. 10 is a diagram that schematically illustrates obtaining of privacy-level management information in the agent robot 30.

FIG. 11 is a diagram that illustrates an example of a user-information recording window displayed in a communication terminal 10 when user information is recorded in the server 20.

FIG. 12 is a diagram that illustrates an example of a user-information recording window displayed in the communication terminal 10 when user information is recorded in the server 20.

FIG. 13 is a diagram that illustrates an example of a privacy-level-management-information recording window displayed when privacy-level management information is recorded in the server 20.

FIG. 14 is a diagram that illustrates examples of answers of the agent robot 30.

FIG. 15 is a diagram that schematically illustrates a process of the agent robot 30.

FIG. 16 is a flowchart that illustrates a process of recording privacy-level management information.

FIG. 17 is a flowchart that illustrates a process of sharing privacy-level management information.

FIG. 18 is a flowchart that illustrates the process of sharing privacy-level management information.

FIG. 19 is a flowchart that illustrates a process of obtaining privacy-level management information.

FIG. 20 is a flowchart that illustrates a process of setting privacy levels for an answer.

FIG. 21 is a flowchart that illustrates the process of setting privacy levels for an answer.

FIG. 22 is a flowchart that illustrates the process of setting privacy levels for an answer.

FIG. 23 is a flowchart that illustrates the process of setting privacy levels for an answer.

FIG. 24 is a flowchart that illustrates the process of setting privacy levels for an answer.

FIG. 25 is a flowchart that illustrates a process of an answer.

FIG. 26 is a diagram that illustrates another example of use of the agent robot 30.

FIG. 27 is a flowchart that illustrates a process of recording privacy-level management information in a case where the agent robot 30 is used as a home agent.

FIG. 28 is a diagram that illustrates another example of use of the agent robot 30.

FIG. 29 is a block diagram that illustrates an example of configuration of an exemplary embodiment of a computer to which the present technology is applied.

### MODE FOR CARRYING OUT THE INVENTION

### 1. First Exemplary Embodiment

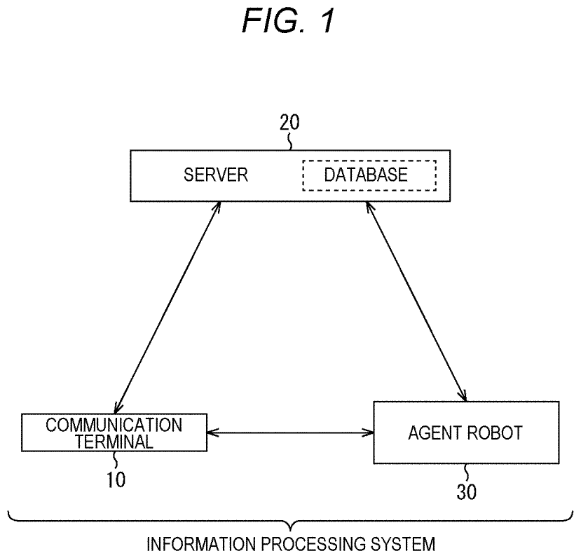

FIG. 1 is a block diagram that illustrates an example of configuration of an information processing system to which the present technology is applied.

The information processing system illustrated in FIG. 1 includes a communication terminal 10, a server 20, and an agent robot 30. Furthermore, wired or wireless communication between the communication terminal 10, the server 20, and the agent robot 30 is performed as necessary through the Internet and other networks that are not illustrated.

The communication terminal 10 communicates with the server 20 to transmit information that will be recorded in (stored in) the server 20. Furthermore, the communication terminal 10 communicates with the agent robot 30 to receive information transmitted from the agent robot 30.

The server 20 receives information transmitted from the communication terminal 10, and records the information in databases. Furthermore, the server 20 communicates with the agent robot 30 to transmit information that has been recorded in the databases to the agent robot 30. Moreover, the server 20 receives information transmitted from the agent robot 30.

From the server 20, the agent robot 30 receives (obtains) information that has been recorded in the databases. Furthermore, the agent robot 30 transmits, to the communication terminal 10 and the server 20, information that the agent robot 30 has obtained.

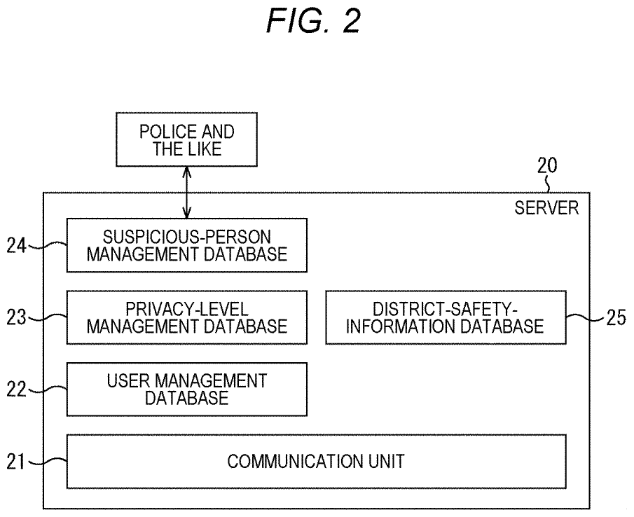

FIG. 2 is a block diagram that illustrates an example of configuration of the server 20.

As illustrated in FIG. 2, the server 20 includes a communication unit 21, a user management database 22, a privacy-level management database 23, a suspicious-person management database 24, and a district-safety-information database 25.

The communication unit 21 communicates with other devices, such as the communication terminal 10 and the agent robot 30 in FIG. 1, to transmit information to and receive information from the devices.

User information that includes personal information regarding users is recorded in the user management database 22.

For example, person information regarding persons that includes features of faces, features of voices, and the like of the persons, and recorded privacy levels that are privacy levels that indicate degrees of disclosure of personal information of a user to the persons, and the like are recorded in the privacy-level management database 23.

Suspicious-person information that is person information of suspicious persons supplied from (shared with), for example, public institutions, such as the police and the like, is recorded in the suspicious-person management database 24.

Degrees of safety that indicate degrees of safety of every district are recorded in the district-safety-information database 25.

Here, the server 20 may be virtually configured in cloud computing.

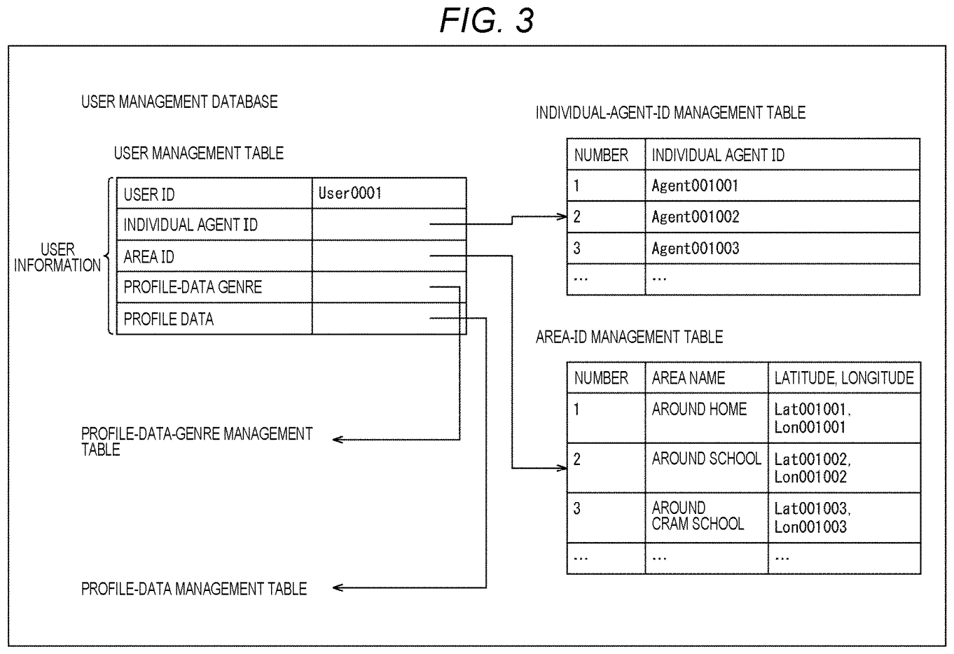

FIG. 3 is a diagram that illustrates an example of configuration of the user management database 22 in FIG. 2.

User information is recorded for every user in the user management database 22. In FIG. 3, the user information is recorded as a user management table.

As illustrated in FIG. 3, the user information, such as a user identification (ID), individual agent IDs, area information, profile-data genres, profile data (personal information), and the like, is recorded in the user management table. That is, the user ID, the individual agent IDs, the area information, the profile-data genres, and the profile data that are associated with each other are recorded in the user management table.

The user ID is a unique identification number assigned to a user who owns agent robots 30, for example.

The individual agent IDs are unique identification numbers assigned to the agent robots 30, respectively. The individual agent IDs are recorded in a form of an individual-agent-ID management table. As illustrated in FIG. 3, the individual agent IDs associated with sequential numbers are recorded in the individual-agent-ID management table. A plurality of individual agent IDs may be recorded in the individual-agent-ID management table. Therefore, in a case where a user owns a plurality of agent robots 30, an individual agent ID of each of the plurality of agent robots 30 is recorded in the individual-agent-ID management table.

The area information is information regarding areas where a user of the user ID (a user identified with the user ID) appears. The area information is recorded in a form of an area-ID management table. For example, area names that are area names, and latitudes and longitudes (latitudes, longitudes) of areas of the area names that are associated with sequential numbers are recorded in the area-ID management table.

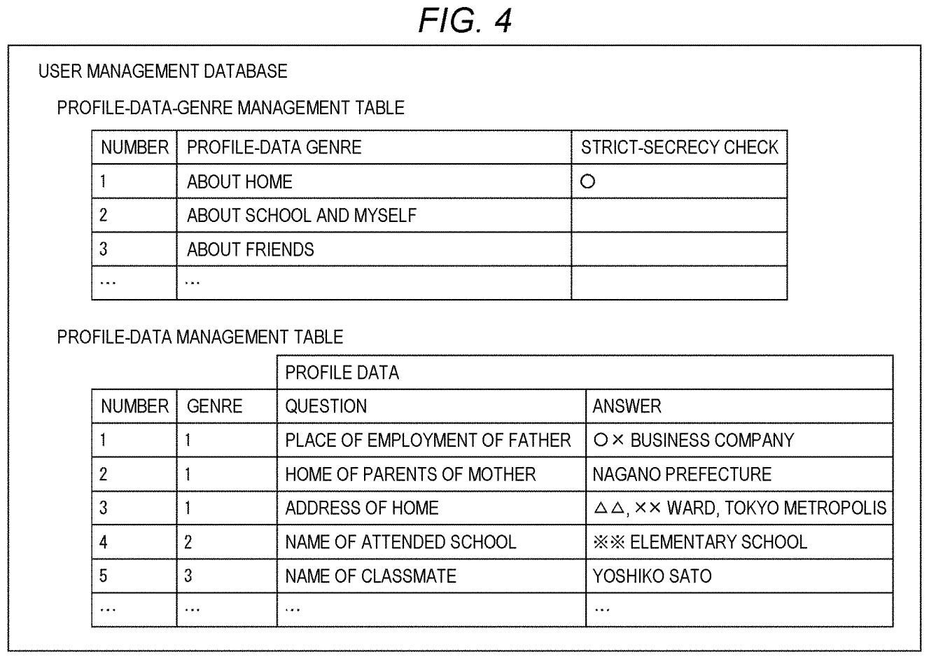

FIG. 4 is a diagram that illustrates an example of configuration of the profile-data genres and the profile data that are recorded in the user management table in FIG. 3.

The profile-data genres indicate genres of the profile data, and are recorded in a form of a profile-data-genre management table. As illustrated in FIG. 4, for example, profile-data genres, and strict-secrecy checks that indicate whether or not the profile-data genres are genres that the user intends to keep secret (strictly secret) are recorded in the profile-data-genre management table. In the profile-data-genre management table, the profile-data genres and the strict-secrecy checks are associated with sequential numbers.

The profile data is personal information of the user, and is recorded in a form of a profile management table. As illustrated in FIG. 4, the profile data and genres, for example, are recorded in the profile management table. In the profile management table, the profile data and the genres are associated with sequential numbers. The profile data includes questions and answers to the questions. Numbers associated with the profile-data genres that indicate genres of the profile data in the profile-data-genre management table are recorded in the genres.

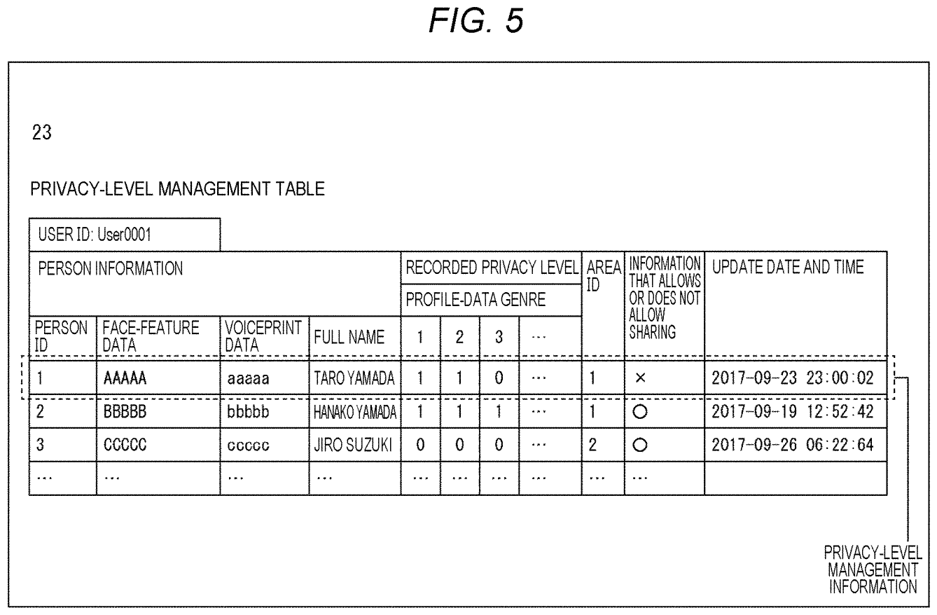

FIG. 5 is a diagram that illustrates an example of configuration of the privacy-level management database 23 in FIG. 2.

In the privacy-level management database 23, a privacy-level management table is recorded for every user. That is, the privacy-level management table is associated with a user ID.

In the privacy-level management table, for example, privacy-level management information for managing privacy of a user is recorded for every person. The privacy-level management information includes person information, and recorded privacy levels, area IDs, information that allows or does not allow sharing, and an update date and time that are associated with each other.

The person information includes a person ID, face-feature data, voiceprint data, and a full name.

The person ID is a sequential identification number assigned to each of persons recorded in the privacy-level management table.

The face-feature data is image features extracted from image data of a face of a person identified with a person ID.

The voiceprint data is voice features extracted from voices of a person identified with a person ID.

The full name indicates a name of a person identified with a person ID.

The recorded privacy levels are privacy levels that have been recorded for a person identified with a person ID. The privacy levels indicate degrees to which personal information regarding a user is disclosed. Hereinafter, privacy levels recorded for a person identified with a person ID is referred to as the recorded privacy levels.

Here, two values, zero or one, are used for the recorded privacy levels to simplify explanation. In a case where the recorded privacy level is one, disclosure is allowed (personal information is disclosed). In a case where the recorded privacy level is zero, disclosure is not allowed (personal information is not disclosed).

In FIG. 5, the recorded privacy levels are recorded for every profile-data genre. In FIG. 5, numbers 1, 2, 3, . . . under the recorded privacy levels indicate numbers associated with the profile-data genres in the profile-data-genre management table (FIG. 4).

The area IDs indicate numbers that have been associated with the area names (FIG. 3) of areas where a person identified with a person ID appears (is met often), and have been recorded in the area-ID management table (FIG. 3).

The information that allows or does not allow sharing indicates whether or not person information recorded in a privacy-level management table of a user identified with a user ID is allowed to be shared with privacy-level management tables of other users that have been recorded in the privacy-level management database 23 of the server 20. In FIG. 5, a circle mark (∘) of the information that allows or does not allow sharing indicates that person information is allowed to be shared with other users, and an × mark (×) of the information that allows or does not allow sharing indicates that person information is not allowed to be shared with other users.

An update date and time indicates a date and time when the privacy-level management information is updated (recorded).

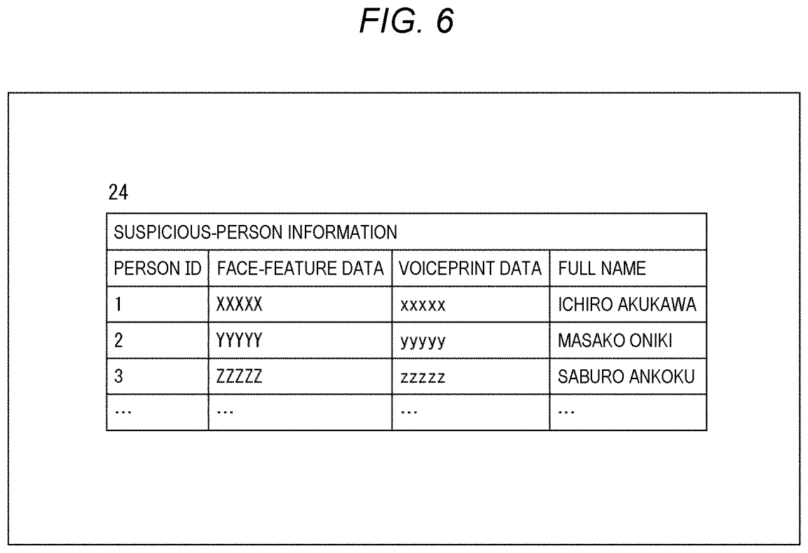

FIG. 6 is a diagram that illustrates an example of configuration of the suspicious-person management database 24 in FIG. 2.

The suspicious-person management database 24, such as suspicious-person information that is person information regarding suspicious persons, is recorded for every person. The suspicious-person information includes a person ID, face-feature data, voiceprint data, and a full name, similarly as the person information in the privacy-level management table (FIG. 5).

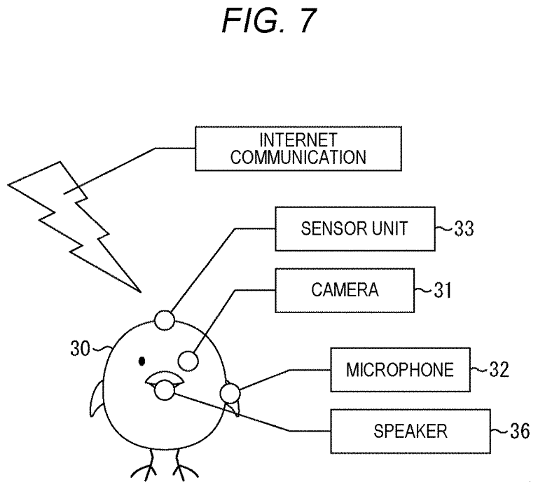

FIG. 7 is an outward-appearance view that schematically illustrates an example of configuration of the agent robot 30 in FIG. 1.

As illustrated in FIG. 7, the agent robot 30 has, for example, a shape of an animal, such as a chick or the like. To recognize a person as a person to be answered, a camera 31 is disposed at a position of an eye of the agent robot 30, a microphone 32 is disposed at a position of an ear of the agent robot 30, and a sensor unit 33 is disposed at a position of a head of the agent robot 30. Furthermore, a speaker 36 is disposed at a position of a mouth of the agent robot 30 to output an answer to an utterance of a person as a person to be answered. Moreover, the agent robot 30 has a communication function to perform communication, such as Internet communication and the like.

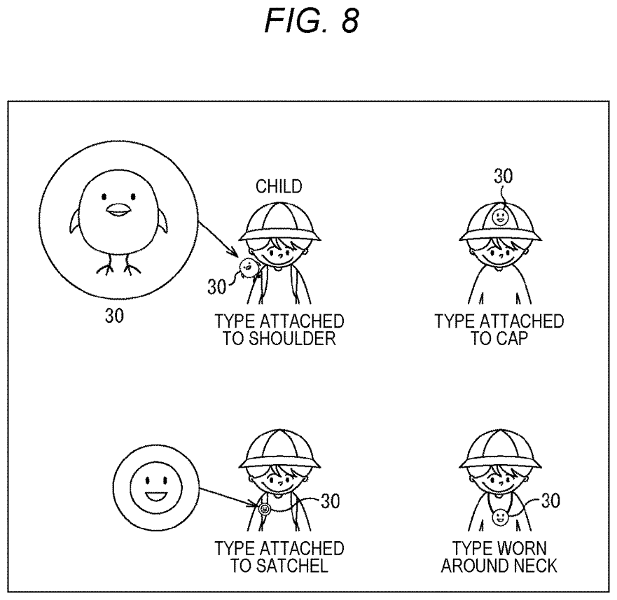

FIG. 8 is a diagram that illustrates an example of use of the agent robot 30 in FIG. 1.

As illustrated in FIG. 8, the agent robot 30 may be made as, for example, a stuffed character toy or a character badge to allow the agent robot 30 to be easily worn by children. Furthermore, the agent robot 30 may have, for example, a shape that allows the agent robot 30 to be worn on a shoulder, a shape that allows the agent robot 30 to be worn around a neck, or a shape that allows the agent robot 30 to be attached to a hat, a satchel, and the like. The agent robot 30 may be made as what is called a portable type.

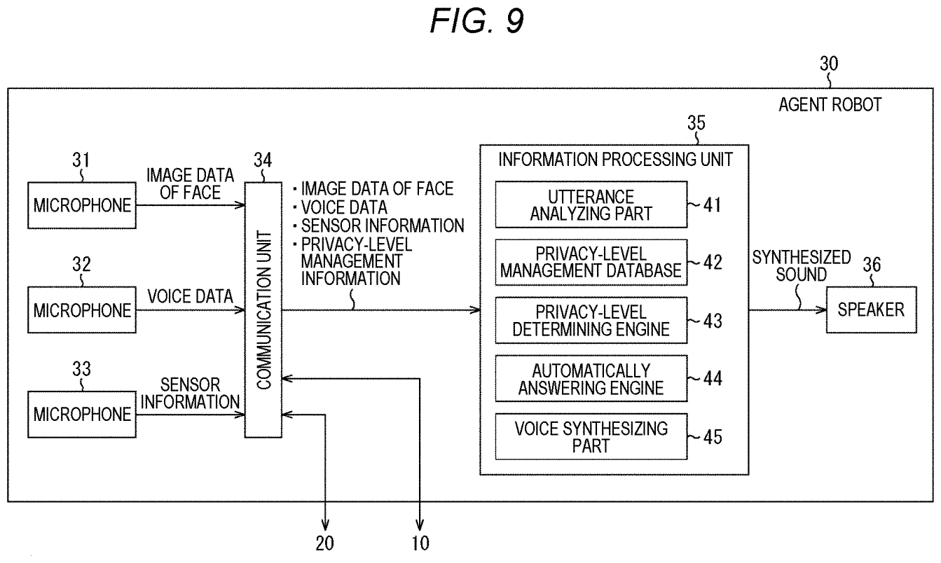

FIG. 9 is a block diagram that illustrates an example of configuration of the agent robot 30.

The agent robot 30 includes the camera 31, the microphone 32, the sensor unit 33, a communication unit 34, an information processing unit 35, and the speaker 36.

The camera 31 captures a face of a person who is opposite the agent robot 30 and is a person to be answered, and supplies, to the communication unit 34, image data of the face that has been obtained from the capturing.

The microphone 32 collects voices of a person to be answered, and supplies voice data obtained by collecting the voices to the communication unit 34.

The sensor unit 33 includes, for example, a laser rangefinder (distance sensor), the global positioning system (GPS) that measures a current location, and a clock that measures time, and other sensors that sense various physical quantities. The sensor unit 33 supplies, to the communication unit 34, sensor information that is information obtained by the sensor unit 33, such as a distance, a current location, a time, and the like.

The communication unit 34 receives the image data of the face from the camera 31, the voice data from the microphone 32, and the sensor information from the sensor unit 33, and supplies the image data of the face, the voice data, and the sensor information to the information processing unit 35. Furthermore, the communication unit 34 transmits the image data of the face from the camera 31, the voice data from the microphone 32, and the sensor information from the sensor unit 33 to the communication terminal 10 or the server 20. Moreover, the communication unit 34 receives privacy-level management information transmitted from the server 20, and supplies the privacy-level management information to the information processing unit 35. Furthermore, the communication unit 34 transmits necessary information to the communication terminal 10 and the server 20, and receives necessary information from the communication terminal 10 and the server 20.

The information processing unit 35 includes an utterance analyzing part 41, a privacy-level management database 42, a privacy-level determining engine 43, an automatically answering engine 44, and a voice synthesizing part 45, and performs various information processing.

The utterance analyzing part 41 uses voice data of a person to be answered that has been supplied from the communication unit 34 to analyze a content of an utterance of the person to be answered. The utterance analyzing part 41 supplies a result of the analysis of the utterance obtained by analyzing the content of the utterance to the automatically answering engine 44.

The privacy-level management database 42 stores privacy-level management information supplied from the communication unit 34.

The privacy-level determining engine 43 extracts face-feature data from an image data of a face of a person to be answered that is supplied from the communication unit 34, and extracts voiceprint data from voice data of the person to be answered that is supplied from the communication unit 34.

Furthermore, the privacy-level determining engine 43 compares the face-feature data and the voiceprint data that have been extracted with person information of privacy-level management information that has been recorded in the privacy-level management database 42, and identifies person information that matches (corresponds to) the person to be answered.

Moreover, the privacy-level determining engine 43 sets privacy levels for an answer, according to recorded privacy levels associated with the person information that matches the person to be answered. The privacy levels for an answer are privacy levels at a time of an answer to the person to be answered. The privacy-level determining engine 43 supplies the privacy levels for an answer to the automatically answering engine 44.

Note that the privacy-level determining engine 43 may also set privacy levels for an answer, according to, for example, sensor information supplied from the communication unit 34 (change setting of privacy levels for an answer).

As described above, the privacy-level determining engine 43 functions as a setting part that sets privacy levels for an answer at a time of an answer to a person to be answered.

The automatically answering engine 44 generates an answer message, according to the result of the analysis of the utterance that is supplied from the utterance analyzing part 41, and according to the privacy levels for an answer that are supplied from the privacy-level determining engine 43. The answer message is an answer message to the result of the analysis of the utterance (a content of the utterance of a person to be answered). The answer message corresponds to (in which disclosure of personal information is limited according to) the privacy levels for an answer. The automatically answering engine 44 supplies the answer message that has been generated to the voice synthesizing part 45.

Note that, to generate an answer message, the automatically answering engine 44 accesses the server 20 through the communication unit 34, and obtains personal information that is necessary to generate the answer message from the profile data of the profile-data management table (FIG. 4).

As described above, the automatically answering engine 44 functions as a generating part that generates an answer message.

The voice synthesizing part 45 synthesizes a voice of the answer message from the automatically answering engine 44 to generate a synthesized sound that corresponds to the answer message, and supplies the synthesized sound to the speaker 36.

The speaker 36 outputs the synthesized sound supplied from the voice synthesizing part 45. Therefore, the voice of the answer message is output.

As described above, the speaker 36 functions as an output unit that outputs an answer message. Note that the answer message may be displayed on a display of the agent robot 30 (output from the display). The display is not illustrated.

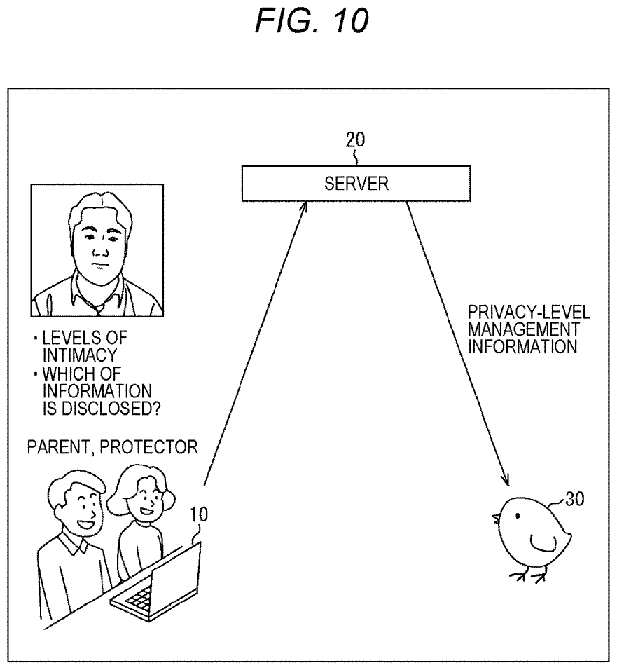

FIG. 10 is a diagram that schematically illustrates obtaining of privacy-level management information in the agent robot 30.

A user who has purchased the agent robot 30, such as a parent or a protector of a child, operates the communication terminal 10 to access the server 20. The user transmits information necessary to generate privacy-level management information from the communication terminal 10 to the server 20. The information necessary to generate privacy-level management information is person information, such as image data of faces, voice data, and the like of persons, such as acquaintances, friends, and the like, levels of intimacy of the persons, information that can be disclosed to the persons, and the like.

The server 20 uses the information that is transmitted from the communication terminal 10 and is necessary to generate privacy-level management information. The server 20 records the privacy-level management information in the privacy-level management table (FIG. 5) of the privacy-level management database 23.

The agent robot 30 requests the server 20 to obtain the privacy-level management information, and obtains the privacy-level management information that has been recorded in the privacy-level management database 23 (FIG. 2) of the server 20. The agent robot 30 stores the privacy-level management information that has been obtained from the server 20 in the privacy-level management database 42 (FIG. 9) of the agent robot 30. According to the privacy-level management information that has been stored in the privacy-level management database 42 of the agent robot 30, the agent robot 30 sets privacy levels for an answer to a person to be answered. The agent robot 30 generates an answer message, according to the privacy levels for an answer.

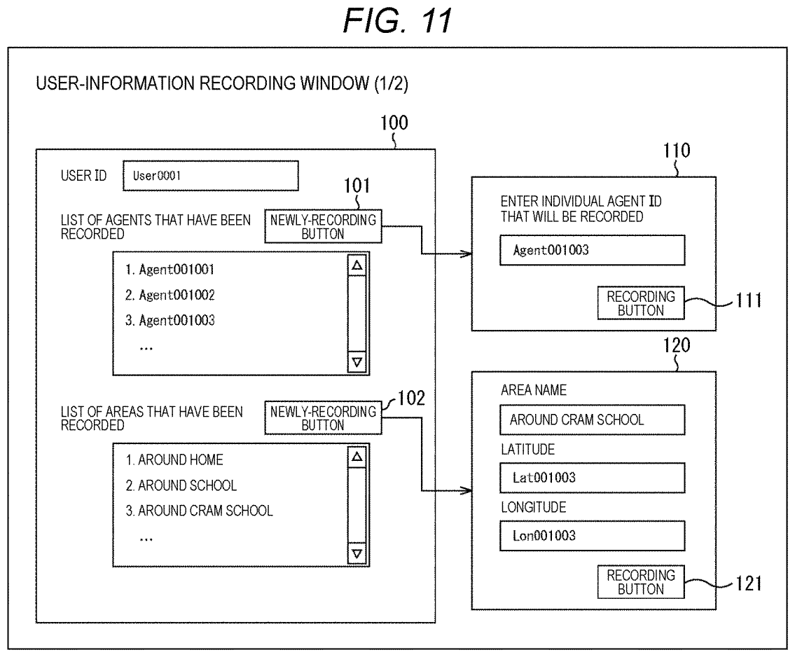

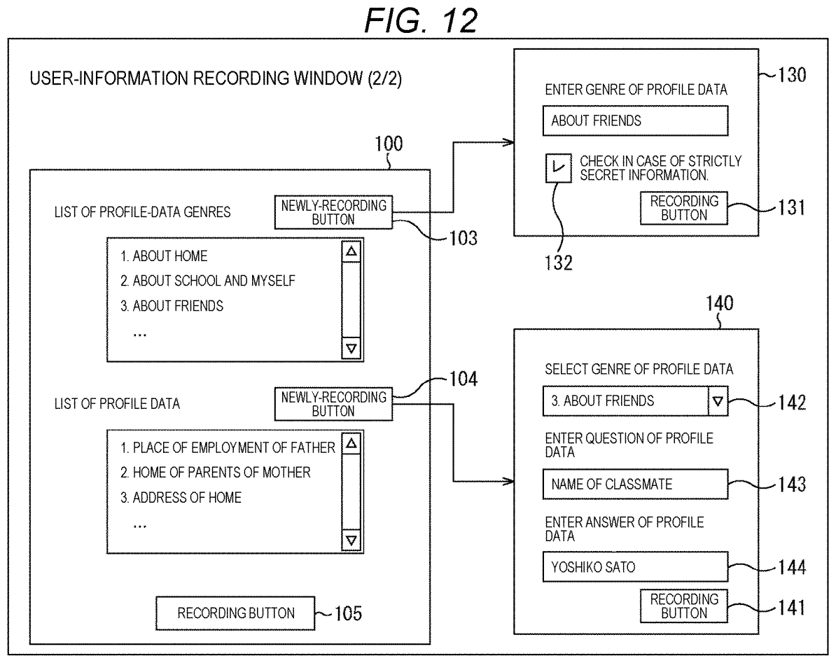

FIGS. 11 and 12 are diagrams that illustrate examples of user-information recording windows. The user-information recording windows are displayed in the communication terminal 10 when user information is recorded in the server 20.

A user who has purchased an agent robot 30, such as a parent or a protector, needs to record user information to receive service of the server 20. The user information is recorded, for example, by accessing the server 20 from the communication terminal 10. Note that the user can record the user information after the server 20 issues a user ID and a password.

The user who has purchased the agent robot 30 operates the communication terminal 10 to enter the user ID and the password, to log on the server 20, and to request recording of user information. In response to the request from the communication terminal 10, the server 20 transmits a user-information recording window to the communication terminal 10. The user-information recording window is for recording user information. Therefore, as illustrated in FIG. 11, the communication terminal 10 displays a window 100 as the user-information recording window. The window 100 displays, for example, a “USER ID”, a “LIST OF AGENTS THAT HAVE BEEN RECORDED”, and a “LIST OF AREAS THAT HAVE BEEN RECORDED”.

In the “USER ID”, the user ID that has been entered by the user to log on the server 20 is displayed.

In the “LIST OF AGENTS THAT HAVE BEEN RECORDED”, a list of individual agent IDs is displayed. The individual agent IDs have been recorded in the individual-agent-ID management table. The individual-agent-ID management table is associated with the user ID in the user management table (FIG. 3). Furthermore, a newly-recording button 101 is disposed to the right of the “LIST OF AGENTS THAT HAVE BEEN RECORDED”. The newly-recording button 101 is operated to newly record an individual agent ID of an agent robot 30.

In a case where a user newly purchases an agent robot 30, the user can perform what is called a product registration of the agent robot 30. In the product registration, the user operates the newly-recording button 101. In response to the operation of the newly-recording button 101, a window 110 is displayed in the communication terminal 10. To record an individual agent ID of the agent robot 30 for which product registration is intended, the user enters the individual agent ID of the agent robot 30 for which product registration is intended in the window 110, and operates a recording button 111 at a bottom of the window 110. That is, the individual agent ID that has been entered in the window 110 is recorded in the individual-agent-ID management table (FIG. 3) that is associated with the user ID of the user in the server 20. Therefore, the individual agent ID that has been entered in the window 110 is added to the “LIST OF AGENTS THAT HAVE BEEN RECORDED” in the window 100.

In the “LIST OF AREAS THAT HAVE BEEN RECORDED”, a list of area information is displayed. The area information has been recorded in the area-information-ID management table that is associated with the user ID in the user management table (FIG. 3). Furthermore, a newly-recording button 102 is disposed to the right of the “LIST OF AREAS THAT HAVE BEEN RECORDED”. The newly-recording button 102 is operated to newly record area information.

In a case where the user wants to newly record an area, the user can record the area. In the recording of the area, the user operates the newly-recording button 102. In response to the operation of the newly-recording button 102, a window 120 is displayed in the communication terminal 10. In the window 120, the user enters, for example, an area name, a latitude, and a longitude of the area recording of which is intended. The user operates a recording button 121 at a bottom of the window 120 to record the area recording of which is intended. That is, the area name, the latitude, and the longitude that are entered in the window 120 are recorded in the area-ID management table (FIG. 3) that is associated with the user ID of the user in the server 20. Therefore, the area information that has been entered in the window 120 is added to the “LIST OF AREAS THAT HAVE BEEN RECORDED” in the window 100.

The user records area names, latitudes, and, longitudes of areas and the like that are visited often, such as a home of the user, a school, a cram school, a nearest station, and the like, in the area-ID management table. Here, a predetermined area around a center that is a latitude and a longitude that have been recorded in the area-ID management table, e.g. an area within a radius of 500 m from a center that is a latitude and a longitude that have been recorded in the area-ID management table, or the like, is used as an area where the user appears.

As illustrated in FIG. 12, a “LIST OF PROFILE-DATA GENRES” and a “LIST OF PROFILE DATA” are displayed in the window 100 by scrolling or switching between pages.

In the “LIST OF PROFILE-DATA GENRES”, a list of profile-data genres that have been recorded in the profile-data-genre management table (FIG. 4) is displayed. Furthermore, a newly-recording button 103 is disposed to the right of the “LIST OF PROFILE-DATA GENRES”. The newly-recording button 103 is operated to newly record a profile-data genre.

In a case where a user wants to newly record a profile-data genre, the user can record the profile-data genre. In the recording of the profile-data genre, the user operates the newly-recording button 103. In response to the operation of the newly-recording button 103, a window 130 is displayed in the communication terminal 10. In the window 130, to record a new profile-data genre, the user enters a profile-data genre recording of which is intended, checks a strict-secrecy checkbox 132 as necessary, and operates a recording button 131 at a bottom of the window 130. That is, a new profile-data genre entered in the window 130 is recorded in the profile-data-genre management table (FIG. 4) associated with the user ID of the user in the server 20. Therefore, the profile-data genre that has been entered in the window 130 is added to the “LIST OF PROFILE-DATA GENRES” of the window 100.

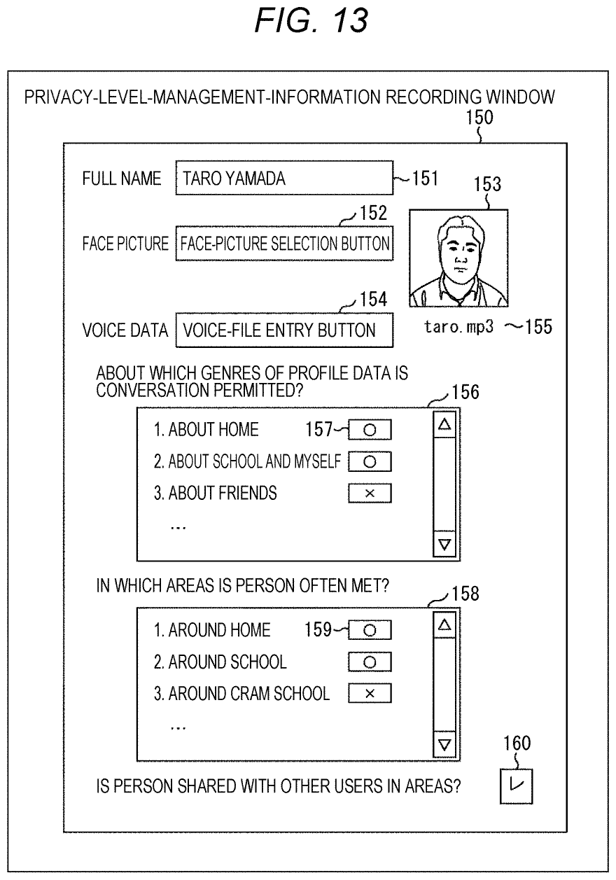

Note that in a case where the strict-secrecy checkbox 132 is checked, a strict-secrecy check that indicates whether or not the profile-data genre that has been entered in the window 130 is a genre that the user intends to keep secret (strictly secret) is recorded in the profile-data-genre management table (FIG. 4). Profile data of a profile-data genre whose strict-secrecy check has been recorded in the profile-data-genre management table is only disclosed (included in an answer message) to a person for whom permission for conversation has been specifically recorded in a privacy-level-management-information recording window (FIG. 13) as described later.

In the “LIST OF PROFILE DATA”, a list of (questions of) profile data that has been recorded in the profile-data management table (FIG. 4) is displayed. Furthermore, a newly-recording button 104 is disposed to the right of the “LIST OF PROFILE DATA”. The newly-recording button 104 is operated to newly record profile data.

In a case where the user wants to newly record profile data, the user can record the profile data. In the recording of the profile data, the user operates the newly-recording button 104. In response to the operation of the newly-recording button 104, a window 140 is displayed in the communication terminal 10. In the window 140, a selection box 142, an entry box 143, and an entry box 144 are displayed. The selection box 142 displays profile-data genres that have been recorded in the profile-data-genre management table (FIG. 4) in a pull-down menu. In the entry box 143, a question of the profile data is entered. In the entry box 144, an answer to (the question of) the profile data is entered.

In the window 140, to record new profile data, the user selects a profile-data genre from the pull-down menu of the selection box 142, enters a question that becomes profile data in the entry box 143, enters an answer to the question in the entry box 144, and operates a recording button 141 at a bottom of the window 140. That is, new profile data that has been entered in the window 140, that is, a profile-data genre that has been selected in the selection box 142, a question that has been entered in the entry box 143, and an answer that has been entered in the entry box 144 are recorded in the profile-data management table (FIG. 4) associated with the user ID of the user of the communication terminal 10 in the server 20. Therefore, the (question of) profile data that has been newly entered in the window 140 is added to the “LIST OF PROFILE DATA” of the window 100.

Here, profile-data genres displayed in the pull-down menu of the selection box 142 of the window 140 are profile-data genres that have been recorded in the profile-data-genre management table (FIG. 4) of the user management database 22 (FIG. 2). Furthermore, a question that has been entered in the entry box 143 of the window 140 and an answer to the question that has been entered in the entry box 144 of the window 140 are paired as profile data, and the profile data is recorded in the profile-data management table (FIG. 4) of the user management database 22.

A recording button 105 at a bottom of the window 100 is operated to record information that has been entered in the window 100 in the user management database (FIG. 3) of the server 20, similarly as, for example, the recording button 111, the recording button 121, the recording button 131, the recording button 141.

FIG. 13 is a diagram that illustrates an example of a privacy-level-management-information recording window displayed when privacy-level management information is recorded in the server 20.

The user operates the communication terminal 10 to enter the user ID and the password, to log on the server 20, and to request recording of privacy-level management information. In response to the request from the communication terminal 10, the server 20 transmits a privacy-level-management-information recording window to the communication terminal 10. Therefore, as illustrated in FIG. 13, a window 150 as the privacy-level-management-information recording window is displayed in the communication terminal 10.

As illustrated in FIG. 13, for example, a full-name entry column 151, a face-picture selection button 152, a face-picture icon 153, a voice-file entry button 154, a file name 155 of a voice file, a conversation permitting column 156, an area column 158, and a checkbox 160 are displayed in the window 150.

In the entry column 151 in the window 150, a name of a person whose privacy-level management information is being recorded is entered. In the entry column 151, the user enters a name of a person recording of privacy-level management information of whom is intended. The name that has been entered in the entry column 151 is recorded as a full name in person information in the privacy-level management table (FIG. 5).

The face-picture selection button 152 is operated to select (a file of) image data of a face of the person whose privacy-level management information is being recorded. When image data of a face is selected by operating the face-picture selection button 152, an icon that is the image data of the face that has been reduced is displayed as the face-picture icon 153.

Moreover, (a file) of the image data of the face that has been selected by operating the face-picture selection button 152 is transmitted from the communication terminal 10 to the server 20. The server 20 receives the image data of the face from the communication terminal 10, and extracts face-feature data from the image data of the face. The face-feature data is recorded in the person information of the privacy-level management table (FIG. 5).

The voice-file entry button 154 is operated to select (a file of) voice data of the person whose privacy-level management information is being recorded. When voice data is selected by operating the voice-file entry button 154, a file name of the voice data is displayed as a file name 155 of a voice file.

Moreover, (the file) of the voice data that has been selected by operating the voice-file entry button 154 is transmitted from the communication terminal 10 to the server 20. The server 20 receives the voice data from the communication terminal 10, and extracts voiceprint data from the voice data. The voiceprint data is recorded in the person information of the privacy-level management table (FIG. 5).

In the conversation permitting column 156, profile-data genres that have been recorded in the profile-data-genre management table (FIG. 4) of the user management database 22 are displayed. Furthermore, to the right of each of the profile-data genres displayed in the conversation permitting column 156, a button 157 is disposed. The buttons 157 are operated to set recorded privacy levels.

In the conversation permitting column 156, the user operates the buttons 157 to record genres (profile-data genres) conversation about which with the person whose privacy-level management information is being recorded in the window 150 is permitted. For example, every operation of the button 157 alternately switches between permitting conversation (a circle mark) and not permitting conversation (an × mark). In the privacy-level management table (FIG. 5), ones are recorded for recorded privacy levels of profile-data genres conversation about which is permitted, and zeros are recorded for recorded privacy levels of profile-data genres conversation about which is not permitted.

In the area column 158, area names of areas that have been recorded in the area-ID management table (FIG. 3) of the user management database 22 are displayed. Furthermore, to the right of each of the area names displayed in the area column 158, a button 159 is disposed. The buttons 159 are operated to set areas where the person whose privacy-level management information is being recorded is met.

In the area column 158, the user operates the buttons 159 to record areas where the person whose privacy-level management information is being recorded in the window 150 is met. For example, every operation of the button 159 alternately switches an area name of an area to the left of the button 159 between an area where the person whose privacy-level management information is being recorded in the window 150 is met (a circle mark) and an area where the person whose privacy-level management information is being recorded in the window 150 is not met (an × mark). Area IDs of area names related to the buttons 159 that have been switched to circle marks are recorded in the privacy-level management information (FIG. 5).

The checkbox 160 is checked in a case where person information of the person whose privacy-level management information is being recorded in the window 150 (hereinafter may be referred as the person who is a subject of the recording) is shared with other users. Person information of privacy-level management information obtained from information that has been entered in the window 150 whose checkbox 160 is checked is copied as person information of privacy-level management information of other users in the server 20. The server 20 uses the copied person information of the person who is a subject of the recording to generate privacy-level management information of other users regarding the person who is a subject of the recording, and records the privacy-level management information in privacy-level management tables (FIG. 5) of the other users.

As described above, the user checks the checkbox 160 in the window 150, and person information of the person who is a subject of the recording is shared with other users. Consequently, privacy-level management information regarding the person who is a subject of the recording is shared with the other users. Therefore, in a case where a person who is a subject of recording is a reliable person in an area, such as an official in a neighbor association, a staff member in a public facility, a lollipop lady (crossing guard), or the like, who is in contact with a plurality of persons in the area, and privacy-level management information is recorded for the person who is a subject of recording, checking the checkbox 160 eliminates the necessity for other users to perform operation to record privacy-level management information of the person who is in contact with a plurality of persons in the area. The burden is eased.

Furthermore, even in a case where other users have not met a person who is a subject of the recording (in a case where the other users do not have image data of a face and voice data of the person who is a subject of the recording), the sharing of privacy-level management information as described above allows privacy-level management information regarding the person who is a subject of the recording to be recorded in (added to) privacy-level management tables of the other users. Therefore, for example, in a case where a user records privacy-level management information regarding a suspicious person whom the user has met, checking the checkbox 160 and sharing the privacy-level management information regarding the suspicious person with other users help to prevent crime.

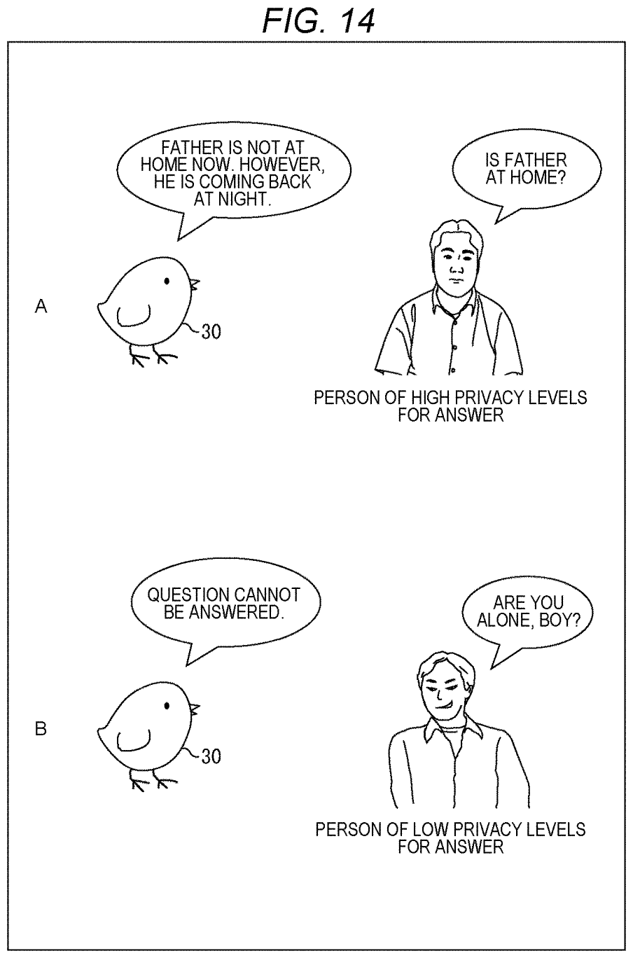

FIG. 14 is a diagram that illustrates examples of answers of the agent robot 30.

The agent robot 30 obtains image data of a face and voice data of a person to be answered with the camera 31 and the microphone 32 that are attached to the agent robot 30, and extracts face-feature data and voiceprint data from the image data of the face and the voice data.

From the privacy-level management table (FIG. 5), the agent robot 30 detects (identifies) person information that matches the face-feature data and the voiceprint data of the person to be answered. The agent robot 30 sets privacy levels for an answer to the person to be answered to recorded privacy levels associated with the person information.

The agent robot 30 generates and outputs an answer message according to the privacy levels for an answer to the person to be answered. For example, in a case where the privacy levels for an answer to the person to be answered are higher, an answer message that discloses personal information is generated and output from the speaker 36. That is, for example, in a case where privacy levels for an answer to a person to be answered who has said “Is father at home?”, as illustrated in A of FIG. 14, are higher, an answer message “Father is not at home now. However, he is coming back at night.” is generated and output from the speaker 36.

Furthermore, for example, in a case where privacy levels for an answer to a person to be answered are lower, an answer message that does not disclose personal information (an answer message in which disclosure of personal information is limited) is generated and output from the speaker 36. That is, for example, in a case where privacy levels for an answer to a person to be answered who has said “Are you alone, boy?”, as illustrated in B of FIG. 14, are lower, an answer message “The question cannot be answered.” is generated and output from the speaker 36.

Here, in a case where the sensor unit 33 of the agent robot 30 includes, for example, a laser rangefinder (distance sensor), the agent robot 30 recognizes a height and a shape of a person to be answered, on the basis of a distance measured with the laser rangefinder, and determines whether the person to be answered is an adult or a child (for example, whether or not the height is not more than 145 cm), on the basis of the height and the shape of the person to be answered.

In a case where the agent robot 30 determines that the person to be answered is an adult, it is inferred that (there is a high possibility that) the person to be answered is a suspicious person. Therefore, lower privacy levels for an answer are set (not to disclose personal information). That is, the agent robot 30 sets privacy levels for an answer to zeros, for example.

Alternatively, in a case where the agent robot 30 determines that the person to be answered is a child, it is inferred that (there is a high possibility that) the person to be answered is not a suspicious person. Therefore, higher privacy levels for an answer are set (to disclose personal information). That is, the agent robot 30 sets privacy levels for an answer to ones, for example.

Furthermore, even in a case where the agent robot 30 determines that a person to be answered is an adult, there is a high possibility that the person to be answered is not a suspicious person when the person to be answered is with a child. Therefore, the agent robot 30 sets higher privacy levels for an answer (to disclose personal information).

Furthermore, in a case where the sensor unit 33 of the agent robot 30 includes, for example, a position-measurement function, such as the GPS or the like, the agent robot 30 obtains a current location with the GPS, transmits the current location to the server 20, and obtains safety information of the current location. Moreover, the agent robot 30 sets privacy levels for an answer on the basis of the safety information that has been obtained from the server 20.

In a case where the safety information indicates that a degree of safety of the current location is low, the agent robot 30 sets lower privacy levels for an answer (not to disclose personal information).

Alternatively, in a case where the safety information indicates that a degree of safety of the current location is high, the agent robot 30 sets higher privacy levels for an answer (to disclose personal information).

Furthermore, in a case where the sensor unit 33 of the agent robot 30 includes, for example, a clock that shows time, the agent robot 30 obtains a current time with the clock, and sets privacy levels for an answer on the basis of the current time.

In a case where the current time is a time in a time slot in which suspicious persons are likely to appear (e.g. a night time slot), the agent robot 30 sets lower privacy levels for an answer (not to disclose personal information).

Alternatively, in a case where the current time is a time in a time slot in which suspicious persons are less likely to appear (e.g. a daytime time slot), the agent robot 30 sets higher privacy levels for an answer (to disclose personal information).

As described above, the agent robot 30 sets privacy levels for an answer that are privacy levels at a time of an answer to a person to be answered, according to information that has been obtained with the camera 31, the microphone 32, and the sensor unit 33. Then, the agent robot 30 generates an answer message that corresponds to the privacy levels for an answer, and makes an answer to an utterance of the person to be answered.

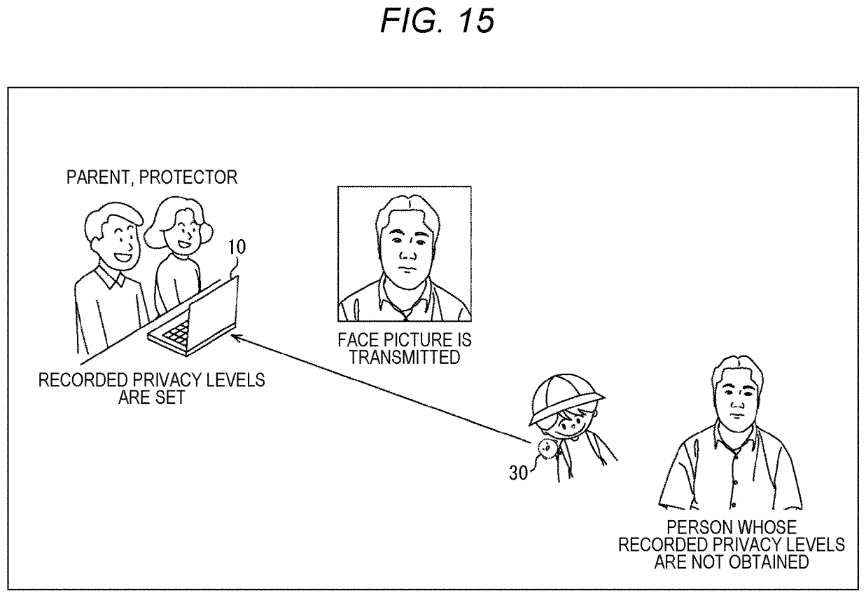

FIG. 15 is a diagram that schematically illustrates a process of the agent robot 30 in a case where face-feature data extracted from image data of a face of a person to be answered and voiceprint data extracted from voice data of the person to be answered do not match any person information of the privacy-level management database 23 (FIG. 5) and the suspicious-person management database 24 (FIG. 6).

In a case where face-feature data extracted from image data of a face of a person to be answered and voiceprint data extracted from voice data of the person to be answered do not match any person information of the privacy-level management database 23 and the suspicious-person management database 24, that is, in a case where the person to be answered is not identified, and thus in a case where recorded privacy levels of the person to be answered are not obtained, the agent robot 30 transmits the image data of the face and the voice data of the person to be answered that have been obtained with the camera 31 and the microphone 32 to the communication terminal 10, and allows a parent or a protector as a user who uses the communication terminal 10 to set (determine) recorded privacy levels of the person to be answered.

As illustrated in FIG. 15, in a case where the agent robot 30 cannot identify a person to be answered, the agent robot 30 transmits image data of a face of a person to be answered that has been obtained with, for example, the camera 31 to the communication terminal 10.

A parent or a protector as a user of the communication terminal 10 that has received the image data of the face of the person to be answered from the agent robot 30 looks at (the person to be answered who appears in) the image data of the face displayed in the communication terminal 10, and operates buttons 157 in the window 150 (FIG. 13) as the privacy-level-management-information recording window to set (enter) recorded privacy levels of the person to be answered (in the present exemplary embodiment, permitting conversation (a circle mark) or not permitting conversation (an × mark)). The setting of the recorded privacy levels is transmitted from the communication terminal 10 to the server 20. The setting of the recorded privacy levels is newly recorded as privacy-level management information in the privacy-level management table (FIG. 5) of the privacy-level management database 23 (FIG. 5) of the server 20. Due to the recording, the person to be answered who has not been identified by the agent robot 30 here will be identified in the future.

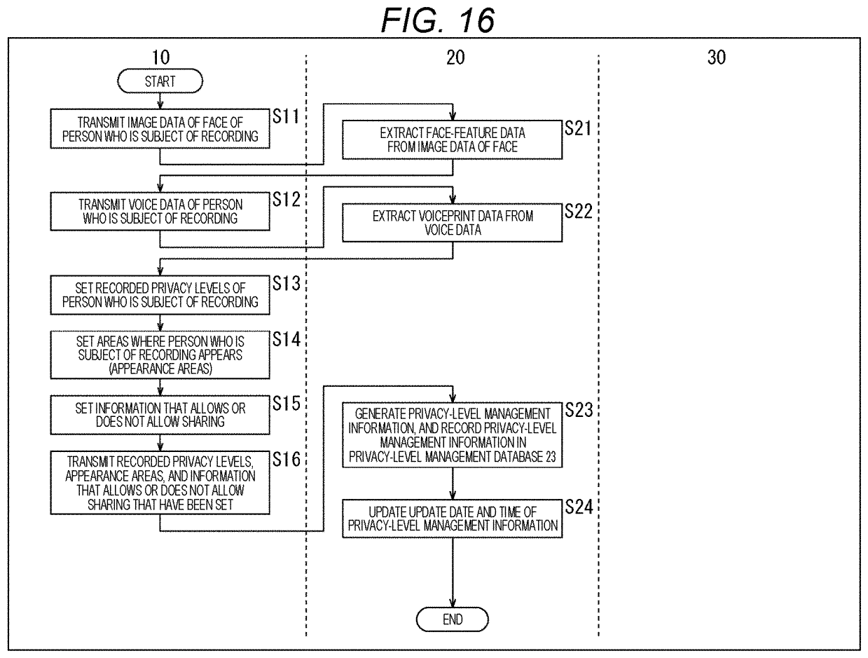

FIG. 16 is a flowchart that illustrates a process of recording privacy-level management information.

In the process of recording privacy-level management information, in response to operation of the communication terminal 10, privacy-level management information is recorded in the server 20.

In step S11, after a user of the communication terminal 10 (a parent or a protector) operates the face-picture selection button 152 in the window 150 (FIG. 13) to record image data of a face of a person who is a subject of the recording whose recorded privacy levels are being recorded, the communication terminal 10 transmits the image data of the face to the server 20, and the process proceeds to step S21.

In step S21, the server 20 receives the image data of the face from the communication terminal 10, and extracts face-feature data from the image data of the face, and the process proceeds to step S12.

In step S12, after the user of the communication terminal 10 (the parent or the protector) operates the voice-file entry button 154 in the window 150 (FIG. 13) to record voice data of the person who is a subject of the recording, the communication terminal 10 transmits the voice data to the server 20, and the process proceeds to step S22.

In step S22, the server 20 receives the voice data from the communication terminal 10, and extracts voiceprint data from the voice data, and the process proceeds to step S13.

In step S13, after the user of the communication terminal 10 operates the buttons 157 of the conversation permitting column 156 in the window 150 (FIG. 13), the communication terminal 10 sets recorded privacy levels of the person who is a subject of the recording, according to the operation of the buttons 157, and the process proceeds to step S14.

In step S14, after the user of the communication terminal 10 operates the buttons 159 of the area column 158 in the window 150 (FIG. 13), the communication terminal 10 sets areas where the person who is a subject of the recording appears, according to the operation of the buttons 159 (hereinafter may be referred to as the appearance areas), and the process proceeds to step S15.

In step S15, according to whether or not the checkbox 160 in the window 150 (FIG. 13) has been checked by the user of the communication terminal 10, the communication terminal 10 sets information that allows or does not allow sharing, and the process proceeds to step S16. The information that allows or does not allow sharing indicates that person information of the person who is a subject of the recording is shared or not shared with other users who appear in the appearance areas of the person who is a subject of the recording.

In step S16, the communication terminal 10 transmits the recorded privacy levels, the appearance areas, and the information that allows or does not allow sharing that have been set in steps S13 to S15 to the server 20, and the process proceeds to step S23.

Note that in a case where the user of the communication terminal 10 enters a full name of the person who is a subject of the recording in the full-name entry column 151 in the window 150 (FIG. 13), the full name is also transmitted in step S16.

In step S23, the server 20 receives the recorded privacy levels, the appearance areas, the information that allows or does not allow sharing, and the full name of the person who is a subject of the recording that are transmitted from the communication terminal 10. Moreover, to generate person information, the server 20 adds a person ID to the face-feature data and the voiceprint data extracted in steps S21 and S22, and the full name of the person who is a subject of the recording from the communication terminal 10. Then, to generate privacy-level management information regarding the person who is a subject of the recording, the server 20 associates the person information with the recorded privacy levels, (the area IDs that indicate) the appearance areas, and the information that allows or does not allow sharing, of the person who is a subject of the recording from the communication terminal 10, and a default update date and time.

The server 20 records the privacy-level management information that has been generated for the person who is a subject of the recording in such a manner that the server 20 adds the privacy-level management information to the privacy-level management table (FIG. 5) of the privacy-level management database 23. The process proceeds from step S23 to step S24.

In step S24, the server 20 updates an update date and time of the privacy-level management information that has been recorded in the privacy-level management table (FIG. 5) to a current date and time, and the process of recording privacy-level management information is ended.

As described above, in the process of recording privacy-level management information, image data of a face and voice data, recorded privacy levels, appearance areas, information that allows or does not allow sharing, and the like regarding a person who is a subject of the recording are transmitted from the communication terminal 10 to the server 20. Consequently, privacy-level management information is recorded in the server 20. In the privacy-level management information, person information is associated with the recorded privacy levels and the like. The person information includes face-feature data and voiceprint data.

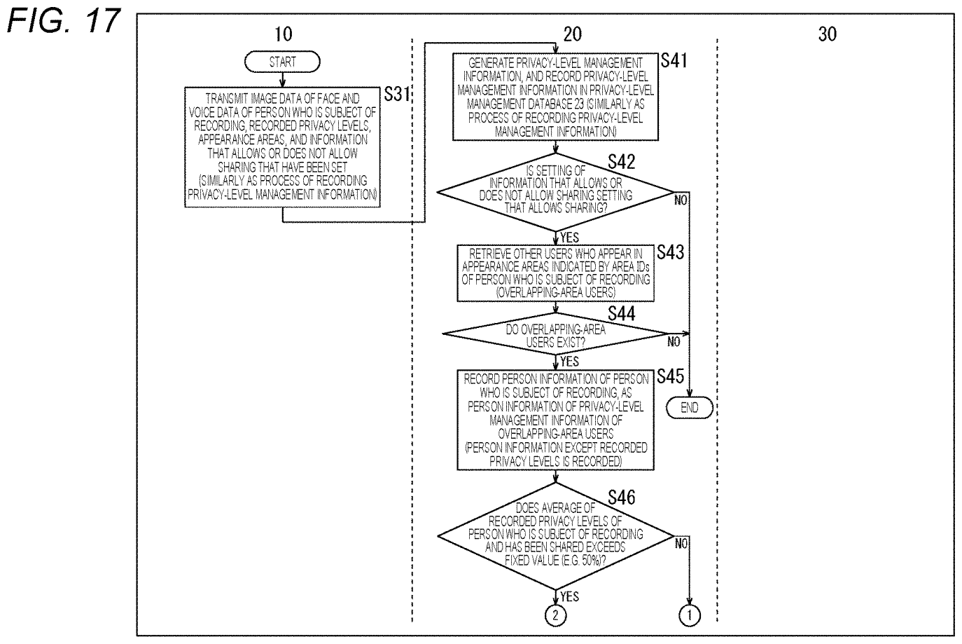

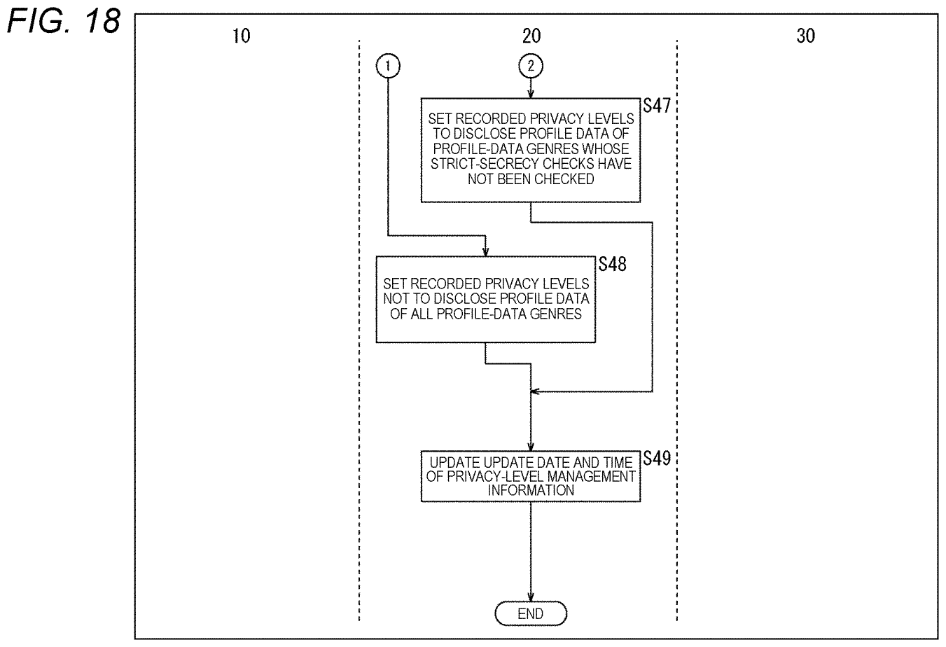

FIGS. 17 and 18 are flowcharts that illustrate a process of sharing privacy-level management information.

In the process of sharing privacy-level management information, person information of privacy-level management information of a user is shared as person information of privacy-level management information of other users. Consequently, privacy-level management information of the other users is automatically generated, as it were. Therefore, a burden of operation for recording the privacy-level management information on the other users is eased.

In step S31, the communication terminal 10 performs a process that is similar to the process of recording privacy-level management information in FIG. 16. The process proceeds from step S31 to step S41.

In step S41, to record privacy-level management information regarding a person who is a subject of the recording, in the privacy-level management table (FIG. 5) of the privacy-level management database 23, the server 20 performs a process that is similar to the process of recording privacy-level management information in FIG. 16. Then, the process proceeds from step S41 to step S42.

In step S42, the server 20 determines whether or not information that allows or does not allow sharing, of privacy-level management information regarding the person who is a subject of the recording indicates that person information of the person who is a subject of the recording is shared with other users.

In a case where in step S42, it is determined that the information that allows or does not allow sharing indicates that the person information is shared with other users, the process proceeds to step S43. Alternatively, in a case where in step S42, the information that allows or does not allow sharing does not indicate that the person information is shared with other users, the process of sharing privacy-level management information is ended.

In step S43, the server 20 retrieves other users who appear in appearance areas indicated by area IDs of the privacy-level management information (FIG. 5) regarding the person who is a subject of the recording (users except a user of the communication terminal 10 who has recorded the privacy-level management information of the person who is a subject of the recording).

That is, the server 20 retrieves other users who have recorded, in area-ID management tables (FIG. 3), an area that overlaps appearance areas indicated by area IDs of the privacy-level management information (FIG. 5) regarding the person who is a subject of the recording. Then, the process proceeds from step S43 to step S44.

In step S44, on the basis of a result of the retrieval of other users who have recorded, in the area-ID management tables (FIG. 3), an area that overlaps appearance areas indicated by area IDs of the privacy-level management information (FIG. 5) regarding the person who is a subject of the recording, the server 20 determines whether or not such other users (hereinafter may be referred to as the overlapping-area users) exist.

In a case where in step S44, it is determined that the overlapping-area users exist, the process proceeds to step S45. Alternatively, in a case where in step S44, it is determined that the overlapping-area users do not exist, the process of sharing privacy-level management information is ended.

In step S45, to generate privacy-level management information of the overlapping-area users regarding the person who is a subject of the recording, the server 20 copies person information of the privacy-level management information regarding the person who is a subject of the recording, as person information of privacy-level management information of the overlapping-area users. The server 20 records the privacy-level management information of the overlapping-area users regarding the person who is a subject of the recording in the privacy-level management tables (FIG. 5) of the overlapping-area users.

Here, to generate the privacy-level management information of the overlapping-area users regarding the person who is a subject of the recording, the server 20 copies the privacy-level management information of the user of the communication terminal 10 regarding the person who is a subject of the recording except recorded privacy levels.

Users may have respective different profile-data genres of recorded privacy levels in privacy-level management information. That is, profile-data genres (FIG. 4) that have been recorded by the user of the communication terminal 10 may be different from profile-data genres that have been recorded by the overlapping-area users. Therefore, in the server 20, recorded privacy levels of privacy-level management information of the overlapping-area users regarding the person who is a subject of the recording are set as follows:

That is, in step S45, the server 20 calculates an average of recorded privacy levels that have been recorded for profile-data genres, respectively, in privacy-level management information of the user of the communication terminal 10 regarding the person who is a subject of the recording. The process proceeds to step S46.

In step S46, the server 20 determines whether or not the average of recorded privacy levels in the privacy-level management information of the user of the communication terminal 10 regarding the person who is a subject of the recording exceeds a fixed value, e.g. 50%.

In a case where in step S46, it is determined that the average of recorded privacy levels exceeds the fixed value, the process proceeds to step S47 in FIG. 18.

Here, in a case where the average of recorded privacy levels exceeds the fixed value (in a case where the person who is a subject of the recording is a person to whom a higher degree of personal information can be disclosed), it is inferred that the person who is a subject of the recording is a person who is reliable to some degree, such as a “government official” or the like. Here, in step S47, the server 20 sets recorded privacy levels to disclose profile data of profile-data genres in privacy-level management information (FIG. 5) of the overlapping-area users regarding the person who is a subject of the recording whose strict-secrecy checks have not been checked in the profile-data-genre management tables (FIG. 4) (sets the recorded privacy levels to ones).

Moreover, the server 20 sets recorded privacy levels not to disclose profile data of profile-data genres in privacy-level management information of the overlapping-area users regarding the person who is a subject of the recording whose strict-secrecy checks have been checked in the profile-data-genre management tables (sets the recorded privacy levels to zeros). Then, the process proceeds from step S47 to step S49.

Alternatively, in a case where in step S46 in FIG. 17, it is determined that the average of recorded privacy levels does not exceed the fixed value, the process proceeds to step S48 in FIG. 18.

Here, in a case where the average of recorded privacy levels does not exceed the fixed value (in a case where the person who is a subject of the recording is a person to whom a lower degree of personal information can be disclosed), it is inferred that the person who is a subject of the recording is a person who is not reliable, such as a “suspicious person” or the like. Here, in step S48, the server 20 sets recorded privacy levels not to disclose profile data of profile-data genres in privacy-level management information (FIG. 5) of the overlapping-area users regarding the person who is a subject of the recording (sets the recorded privacy levels to zeros). Then, the process proceeds from step S48 to step S49.

In step S49, the server 20 updates an update date and time of the privacy-level management information of the overlapping-area users regarding the person who is a subject of the recording to a current date and time, and the process of sharing privacy-level management information is ended.

As described above, in the process of sharing privacy-level management information, person information of privacy-level management information regarding a person who is a subject of the recording is shared with the overlapping-area users, as person information of privacy-level management information of the overlapping-area users. Moreover, in the process of sharing privacy-level management information, person information that is shared is used to generate privacy-level management information regarding a person who is a subject of the recording, and the privacy-level management information regarding the person who is a subject of the recording is recorded in privacy-level management tables (FIG. 5) of the overlapping-area users. Therefore, a burden of setting of recorded privacy levels on the overlapping-area users is eased.

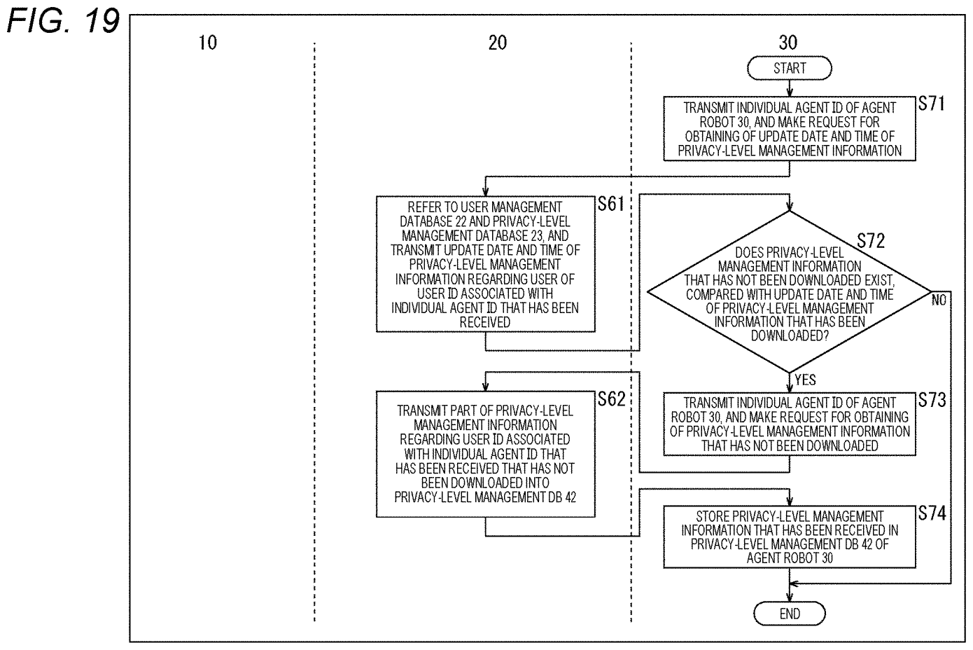

FIG. 19 is a flowchart that illustrates a process of obtaining privacy-level management information.

In the process of obtaining privacy-level management information, privacy-level management information (FIG. 5) recorded in the privacy-level management database 42 (FIG. 9) of the agent robot 30 is updated.

In step S71, the agent robot 30 transmits an individual agent ID of the agent robot 30 to the server 20, and makes a request for obtaining of an update date and time of privacy-level management information (FIG. 5). Then, the process proceeds from step S71 to step S61.

In step S61, in response to the request for obtaining from the agent robot 30, the server 20 refers to the user management database 22 (FIG. 3) and the privacy-level management database 23 (FIG. 5), identifies, from the individual agent ID that has been transmitted from the agent robot 30, an update date and time of privacy-level management information (FIG. 5) of a user of a user ID associated with the individual agent ID, and transmits the update date and time to the agent robot 30. Then, the process proceeds from step S61 to step S72.

In step S72, the agent robot 30 compares the update date and time of privacy-level management information from the server 20 with an update date and time of privacy-level management information (FIG. 5) that has been downloaded into (recorded in) the privacy-level management database 42 (FIG. 9) of the agent robot 30, and determines whether or not privacy-level management information that has not been downloaded into the privacy-level management database 42 exists in the server 20.

In a case where in step S72, the agent robot 30 determines that privacy-level management information that has not been downloaded into the privacy-level management database 42 of the agent robot 30 exists in the privacy-level management database 23 of the server 20, the process proceeds to step S73. Alternatively, in a case where in step S72, the agent robot 30 determines that privacy-level management information that has not been downloaded into the privacy-level management database 42 does not exist in the privacy-level management database 23 of the server 20, the process of obtaining privacy-level management information is ended.

In step S73, the agent robot 30 transmits the individual agent ID of the agent robot 30 to the server 20, and makes a request for obtaining of privacy-level management information that has not been downloaded into the privacy-level management database 42, and the process proceeds to step S62.

In step S62, in response to the request for obtaining from the agent robot 30, the server 20 transmits, to the agent robot 30, part of privacy-level management information of a user of a user ID associated with the individual agent ID that has been transmitted from the agent robot 30 that has not been downloaded into the privacy-level management database 42. Then, the process proceeds from step S62 to step S74.

In step S74, the agent robot 30 stores the privacy-level management information that has been transmitted from the server 20 in the privacy-level management database 42 of the agent robot 30. Then, the process of obtaining privacy-level management information is ended.

As described above, in the process of obtaining privacy-level management information, the agent robot 30 obtains (downloads) privacy-level management information that has not been downloaded into the privacy-level management database 42, according to an update date and time of privacy-level management information, and updates recorded contents of the privacy-level management database 42. Therefore, privacy-level management information stored in the privacy-level management database 42 is quickly updated.

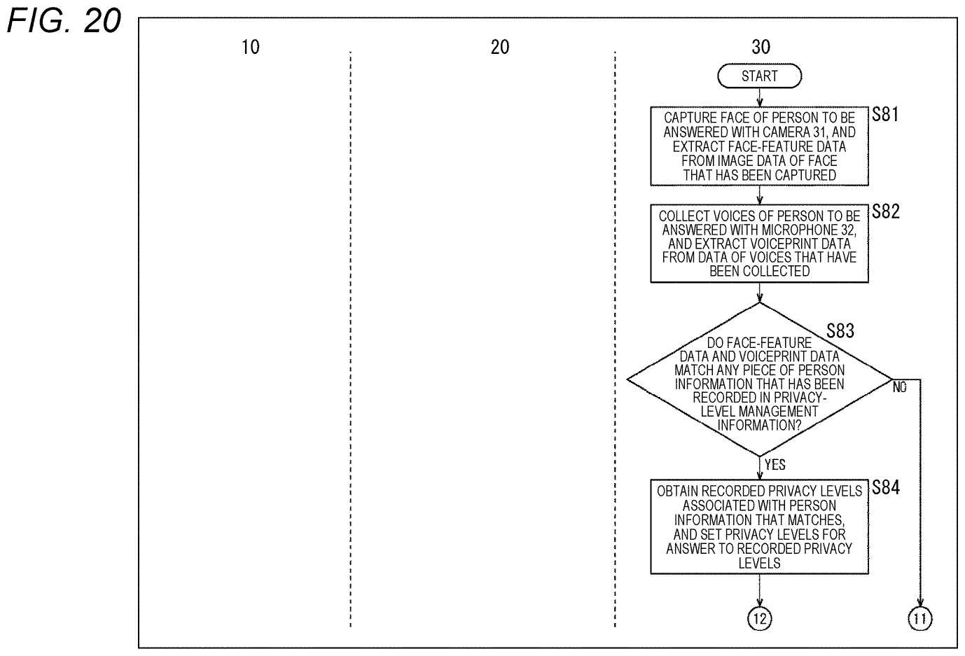

FIGS. 20 to 24 are flowcharts that illustrate a process of setting privacy levels for an answer.

In the process of setting privacy levels for an answer, privacy levels for an answer at a time of an answer to a person to be answered are set.

In step S81, the agent robot 30 captures a face of a person to be answered with the camera 31, and extracts face-feature data from image data of the face that has been captured, and the process proceeds to step S82.

In step S82, the agent robot 30 collects voices of the person to be answered with the microphone 32, and extracts voiceprint data from data of the voices that have been collected, and the process proceeds to step S83.

In step S83, the agent robot 30 determines whether or not the face-feature data and the voiceprint data of the person to be answered match any piece of person information that has been recorded in privacy-level management information (FIG. 5) that has been stored in the privacy-level management database 42.

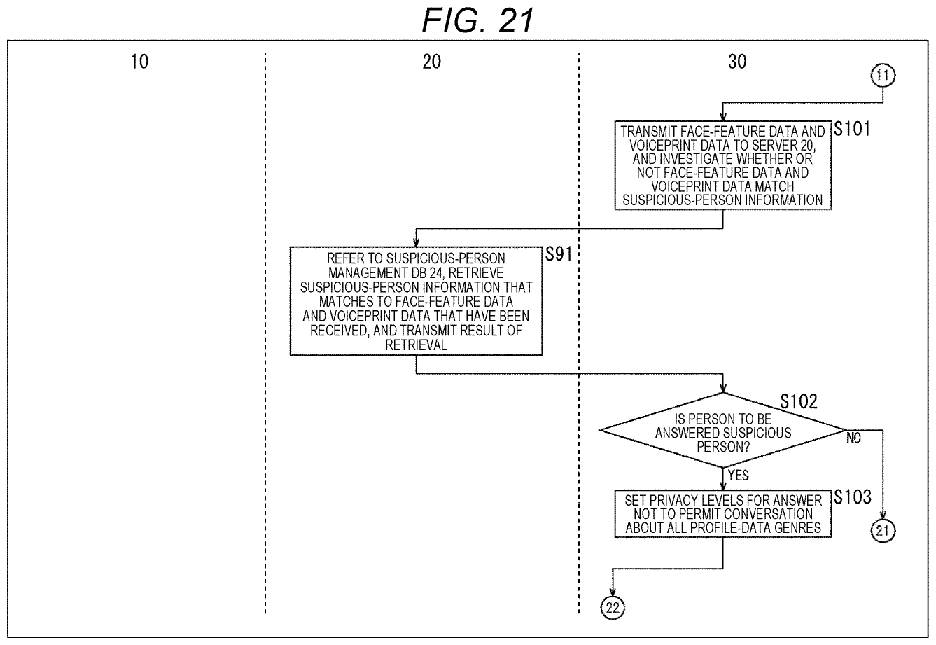

In a case where in step S83, the agent robot 30 determines that the face-feature data and the voiceprint data of the person to be answered match any piece of person information that has been recorded in privacy-level management information that has been stored in the privacy-level management database 42, the process proceeds to step S84. Alternatively, in a case where in step S83, the agent robot 30 determines that the face-feature data and the voiceprint data of the person to be answered do not match any piece of person information that has been recorded in privacy-level management information (FIG. 5) that has been stored in the privacy-level management database 42, the process proceeds to step S101 in FIG. 21.

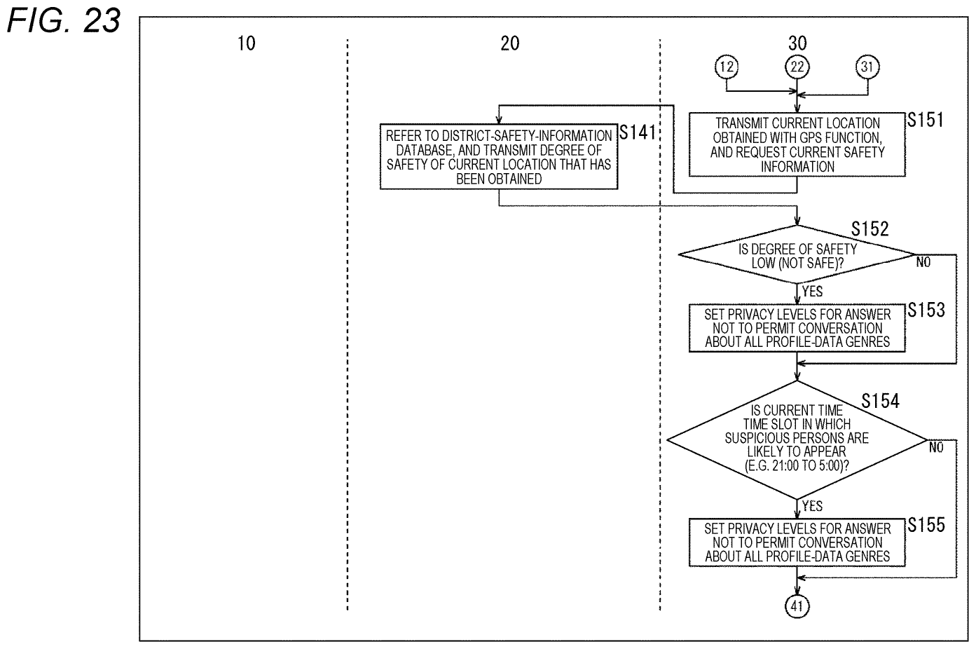

In step S84, the agent robot 30 obtains recorded privacy levels associated with person information that matches the face-feature data and the voiceprint data of the person to be answered, and sets privacy levels for an answer to the recorded privacy levels, and the process proceeds to step S151 in FIG. 23.

In step S101 in FIG. 21, the agent robot 30 transmits, to the server 20, the face-feature data and the voiceprint data of the person to be answered, and requests the server 20 to investigate whether or not the face-feature data and the voiceprint data of the person to be answered match any piece of suspicious-person information (FIG. 6) of suspicious persons that has been recorded in the suspicious-person management database 24, and the process proceeds to step S91.

In step S91, in response to the request of investigation from the agent robot 30, the server 20 refers to the suspicious-person management database 24, and retrieves suspicious-person information that matches the face-feature data and the voiceprint data of the person to be answered that have been transmitted from the agent robot 30. Then, the server 20 transmits a result of the retrieval of suspicious-person information to the agent robot 30, and the process proceeds from step S91 to step S102.

In step S102, on the basis of the result of the retrieval of suspicious-person information that has been transmitted from the server 20, the agent robot 30 determines whether or not the person to be answered is a suspicious person.

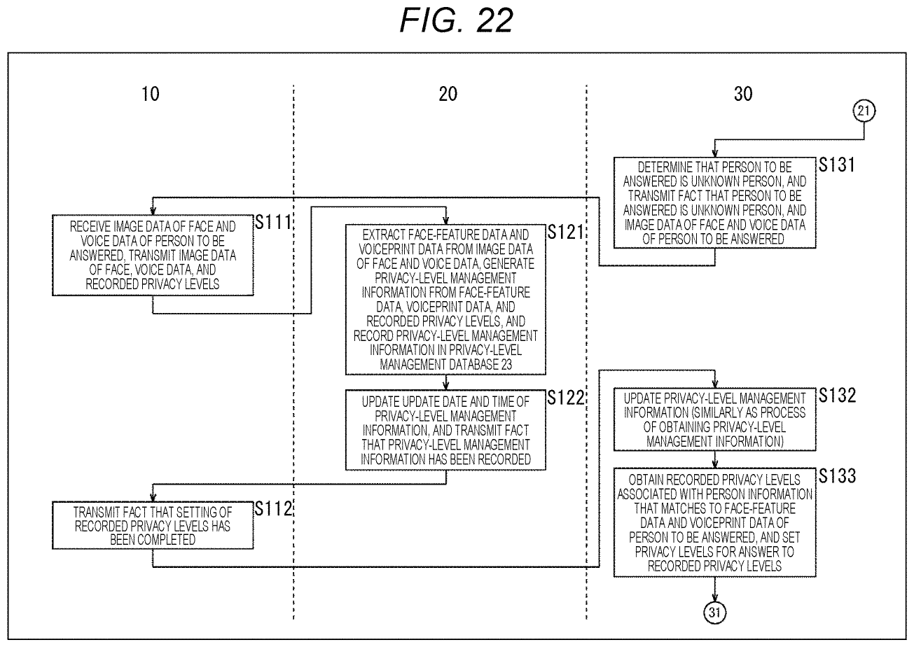

In a case where in step S102, it is determined that the person to be answered is a suspicious person, that is, in a case where the face-feature data and the voiceprint data of the person to be answered match any piece of suspicious-person information that has been recorded in the suspicious-person management database 24, the process proceeds to step S103. Alternatively, in a case where in step S102, it is determined that the person to be answered is not a suspicious person, that is, in a case where the face-feature data and the voiceprint data of the person to be answered do not match any suspicious-person information that has been recorded in the suspicious-person management database 24, the process proceeds to step S131 in FIG. 22.

In step S103, the agent robot 30 sets privacy levels for an answer to the person to be answered who is a suspicious person not to permit conversation about all profile-data genres. Then, the process proceeds to step S151 in FIG. 23.

In step S131 in FIG. 22, the agent robot 30 determines that the person to be answered is an unknown person since person information that matches the face-feature data and the voiceprint data of the person to be answered does not exist in person information of privacy-level management information stored in the privacy-level management database 42 (FIG. 9) and (suspicious person) person information recorded in the suspicious-person management database 24 (FIG. 6), and transmits, to the communication terminal 10, a message to the effect that the person to be answered is an unknown person (hereinafter may also be referred to as the unknown message). Furthermore, in addition to the unknown message, the agent robot 30 transmits, to the communication terminal 10, the image data of the face and the voice data of the person to be answered who is an unknown person. Then, the process proceeds from step S131 to step S111.

In step S111, the communication terminal 10 receives the image data of the face and the voice data of the person to be answered who is an unknown person from the agent robot 30. Then, a user of the communication terminal 10 looks at an unknown person who appears in the image data of the face of the person to be answered who is an unknown person that has been received from the agent robot 30, and sets recorded privacy levels of the unknown person by operating the buttons 157 in the window 150 (FIG. 13) as the privacy-level-management-information recording window. The communication terminal 10 transmits the recorded privacy levels that have been set by the user, and the image data of the face and the voice data of the unknown person to the server 20. Then, the process proceeds from step S111 to step S121.

In step S121, to generate privacy-level management information (FIG. 5) regarding the unknown person, the server 20 extracts face-feature data and voiceprint data from the image data of the face and the voice data of the person to be answered who is an unknown person that have been transmitted from the communication terminal 10, respectively, and associates person information that includes the face-feature data and the voiceprint data with the recorded privacy levels from the communication terminal 10. The server 20 records the privacy-level management information in the privacy-level management database 23 (FIG. 5). The process proceeds from step S121 to step S122.

In step S122, the server 20 updates an update date and time of the privacy-level management information regarding the unknown person to a current date and time, and transmits, to the communication terminal 10, a fact that the privacy-level management information has been recorded. Then, the process proceeds from step S122 to step S112.

In step S112, in response to the fact transmitted from the server 20 that the privacy-level management information has been recorded, the communication terminal 10 transmits, to the agent robot 30, a fact that setting of the recorded privacy levels has been completed (the privacy-level management information has been recorded). Then, the process proceeds from step S112 to step S132.

In step S132, in response to the fact from the communication terminal 10 that setting of the privacy levels has been completed, the agent robot 30 performs the process of obtaining privacy-level management information that has been described in FIG. 19 to update recorded contents of the privacy-level management database 42 (FIG. 9) to record privacy-level management information (FIG. 5) regarding the unknown person in the privacy-level management database 42. Then, the process proceeds from step S132 to step S133.

In step S133, the agent robot 30 obtains recorded privacy levels associated with person information that matches the face-feature data and the voiceprint data of the person to be answered who is an unknown person from privacy-level management information (FIG. 5) that has been recorded in the privacy-level management database 42 (FIG. 9), and sets privacy levels for an answer to the recorded privacy levels. Then, the process proceeds from step S133 to step S151 in FIG. 23.

In step S151, the agent robot 30 obtains a current location with a global positioning system (GPS) function of the sensor unit 33 (FIG. 9), and transmits the current location to the server 20 to request safety information regarding safety of the current location. Then, the process proceeds from step S151 to step S141.

In step S141, the server 20 receives the current location from the agent robot 30. The server 20 refers to the district-safety-information database 25 to obtain a degree of safety that indicates a degree of safety of the current location of the agent robot 30. The server 20 transmits, to the agent robot 30, the degree of safety that has been obtained from the district-safety-information database 25. Then, the process proceeds from step S141 to step S152.

In step S152, the agent robot 30 determines whether or not a degree of safety of the current location is low (is not safe) on the basis of the degree of safety that has been transmitted from the server 20.

In a case where in step S152, the agent robot 30 determines that the degree of safety of the current location is lower (than a predetermined threshold), the process proceeds to step S153. Alternatively, in a case where in step S152, the agent robot 30 determines that the degree of safety of the current location is high (is safe), the process omits step S153 and proceeds to step S154.

In step S153, the agent robot 30 sets privacy levels for an answer not to permit conversation about all profile-data genres since the degree of safety of the current location is bad. For example, the agent robot 30 sets privacy levels for an answer (of all profile-data genres) to zeros. Then, the process proceeds from step S153 to step S154.

In step S154, the agent robot 30 recognizes a current time by means of a clock of the sensor unit 33 (FIG. 9), and determines whether or not the current time is a time in a time slot in which suspicious persons are likely to appear, e.g. a time slot of night (21:00 to 5:00).

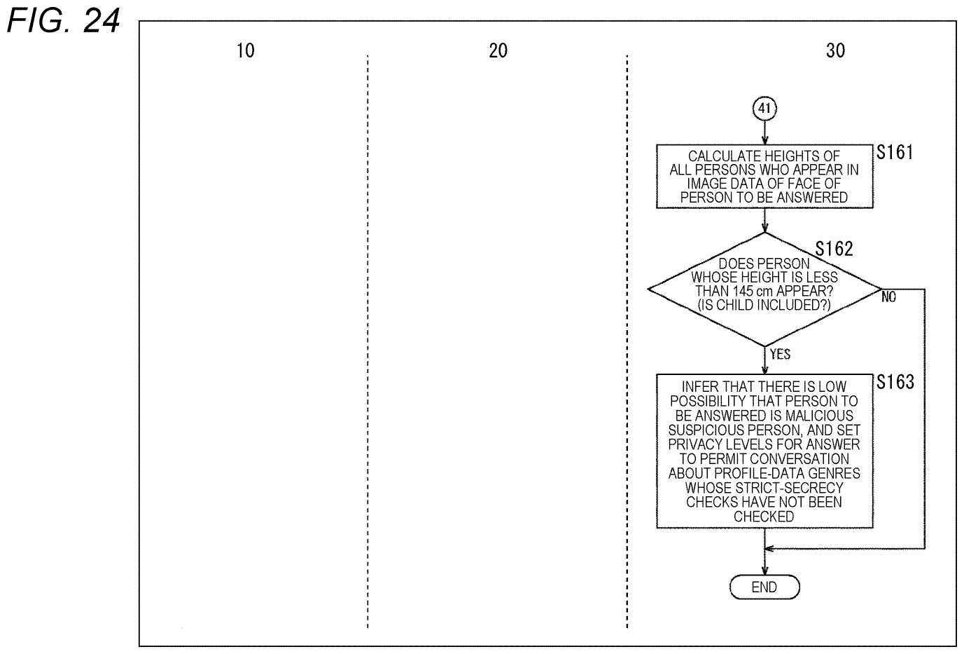

In a case where in step S154, it is determined that the current time is a time in a time slot in which suspicious persons are likely to appear, the process proceeds to step S155. Alternatively, in a case where in step S154, it is determined that the current time is not a time in a time slot in which suspicious persons are likely to appear, the process omits step S155 and proceeds to step S161 in FIG. 24.

In step S155, the agent robot 30 sets privacy levels for an answer not to permit conversation about all profile-data genres since the current time is a time in a time slot in which suspicious persons are likely to appear. For example, the agent robot 30 sets privacy levels for an answer to zeros. Then, the process proceeds from step S155 to step S161 in FIG. 24.

In step S161, the agent robot 30 uses a distance obtained with the laser rangefinder of the sensor unit 33 (FIG. 9) to calculate heights of all persons who appear in the image data of the face captured with the camera 31. Then, the process proceeds from step S161 to step S162.

In step S162, the agent robot 30 determines whether or not a height of any person who appears in the image data of the face is less than, for example, 145 cm.

In a case where in step S162, the agent robot 30 determines that a height of any person who appears in the image data of the face is less than 145 cm, that is, in a case where there is a high possibility that persons who appear in the image data of the face include a child, the process proceeds to step S163. Alternatively, in a case where in step S162, the agent robot 30 determines that a height of any person who appears in the image data of the face is not less than 145 cm, that is, in a case where there is a high possibility that persons who appear in the image data of the face do not include a child, the process of setting privacy levels for an answer is ended.

In step S163, since it is inferred that there is a low possibility that the person to be answered is a malicious suspicious person in a case where persons who appear in the image data of the face include a child, the agent robot 30 sets privacy levels for an answer to permit conversation about profile-data genres whose strict-secrecy checks have not been checked. For example, the agent robot 30 sets privacy levels for an answer (of all profile-data genres whose strict-secrecy checks have not been checked) to ones. Then, the process of setting privacy levels for an answer is ended.

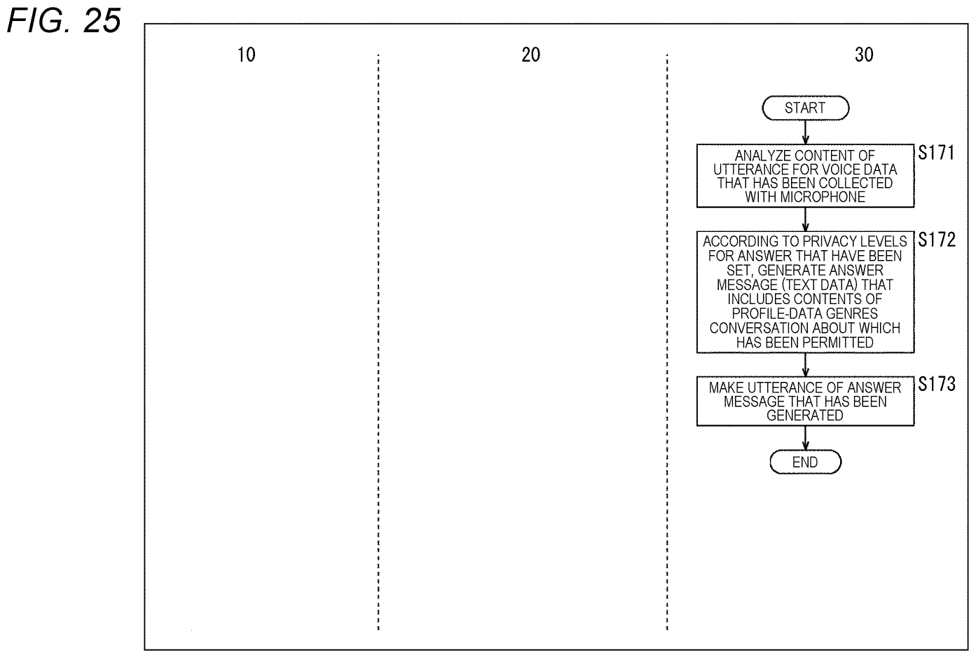

FIG. 25 is a flowchart that illustrates a process of an answer.

In the process of an answer, an answer message to an utterance of a person to be answered is generated and output.

In step S171, the agent robot 30 uses voice data of a person to be answered that has been collected with the microphone 32 to analyze a content of the utterance of the person to be answered, and the process proceeds to step S172.

In step S172, according to privacy levels for an answer that have been set in the process of setting privacy levels for an answer in FIGS. 20 to 24, the agent robot 30 generates an answer message (text data) that includes contents of profile data of profile-data genres conversation about which has been permitted, that is, an answer message in which contents of profile data of profile-data genres conversation about which has not been permitted are limited. Then, the process proceeds from step S172 to step S173.

In step S173, the agent robot 30 synthesizes a voice of the answer message that has been generated to generate a synthesized sound that corresponds to the answer message. Then, the agent robot 30 makes an answer to the person to be answered by outputting the synthesized sound from the speaker 36. The process of an answer is ended.

As described above, in the agent robot 30, privacy levels for an answer that indicate degrees of disclosure of profile data are set according to a person to be answered, and an answer message that corresponds to the privacy levels for an answer is generated. Therefore, the agent robot 30 makes an answer in which disclosure of contents of personal information is limited according to a person to be answered.

A child wears the agent robot 30 as described above, and the agent robot 30 determines (privacy levels for) personal information that can be talked according to a person who has spoken to the child, and makes an answer that corresponds to the person.

Therefore, even in a case where the child cannot determine a person to be answered, the agent robot 30 makes an answer in which personal information is appropriately limited according to the person to be answered.

Furthermore, the agent robot 30 refers to person information that has been recorded in the server 20 by a parent or a protector who is a user of the agent robot 30, and shares person information that has been recorded by other users. Therefore, the agent robot 30 identifies a person to be answered whose person information has not been recorded by the user.

Moreover, the agent robot 30 includes the sensor unit 33 that senses various physical quantities, such as the laser rangefinder (distance sensor), the GPS, the clock, and the like, and sets privacy levels for an answer, considering a current situation where a child who wears the agent robot 30 is.

Note that in FIG. 9, part or all of the information processing unit 35 may not be included in the agent robot 30, but may be included in the server 20.

That is, in FIG. 9, privacy levels for an answer are set by the privacy-level determining engine 43 of the agent robot 30. The privacy-level determining engine 43 is a setting part. However, privacy levels for an answer may be set by the server 20 to which image data of a face and voice data of a person to be answered are transmitted from the agent robot 30. The server 20 identifies a person from the image data of a face and the voice data of the person to be answered that are transmitted from the agent robot 30. That is, the server 20 identifies person information that matches face-feature data extracted from the image data of a face of the person to be answered, and voiceprint data extracted from the voice data of the person to be answered. The server 20 sets privacy levels for an answer, according to recorded privacy levels that are associated with the person information, and transmits the privacy levels for an answer to the agent robot 30.

Furthermore, in FIG. 9, an answer message is generated by the automatically answering engine 44 of the agent robot 30. The automatically answering engine 44 is a generating part. However, an answer message may be generated by the server 20 to which image data of a face and voice data of a person to be answered are transmitted from the agent robot 30. Similarly as the agent robot 30, the server 20 sets privacy levels for an answer from the image data of a face and voice data of the person to be answered that are transmitted from the agent robot 30. Moreover, according to the privacy levels for an answer, the server 20 generates an answer message that answers the voice data from the agent robot 30, and transmits the answer message to the agent robot 30.

Moreover, in FIG. 9, a voice of an answer message is output. However, a voice of an answer message may not be output, and the answer message may be displayed in a screen.

Furthermore, in a case where privacy levels for an answer are ones, the agent robot 30 discloses personal information. In a case where privacy levels for an answer are zeros, the agent robot 30 does not disclose personal information. However, three or more values may be used for privacy levels for an answer. For example, real numbers in a range from zero to one may be used for privacy levels for an answer. Then, according to the privacy levels for an answer of such real numbers, an answer message in which contents of personal information are limited is generated. Furthermore, values within a range that is same as a range within which the privacy levels for an answer are may be used as recorded privacy levels.

In a case where privacy levels for an answer of real numbers are used, privacy levels for an answer that have been set according to recorded privacy levels may be increased or decreased according to a current time, according to whether or not a person to be answered is a child, and the like. A relation between the privacy levels for an answer of real numbers and an answer message in which contents of personal information are limited according to the privacy levels for an answer is learned by, for example, deep learning or the like. A result of the learning is used to generate an answer message.

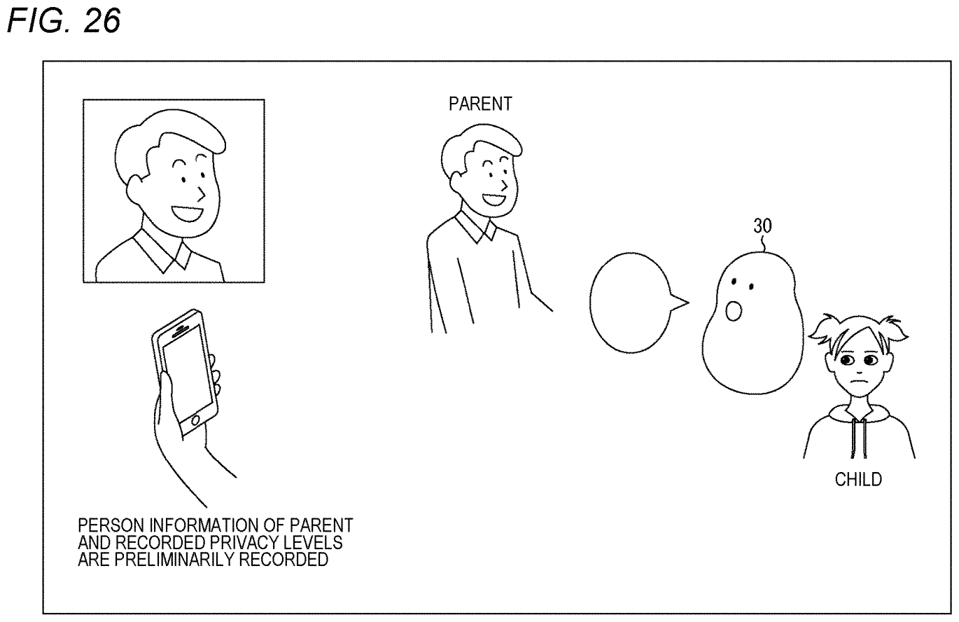

FIG. 26 is a diagram that illustrates another example of use of the agent robot 30.

FIG. 26 illustrates an example of use of the agent robot 30 in which the agent robot 30 is used as, so to speak, a home agent that mediates between an adolescent child who seldom talks with a parent and the parent who is anxious for the child and is trying to talk to the child, in a home, for example.

In a case where the agent robot 30 is used as a home agent, as described above, the agent robot 30 is used in a home. Here, the agent robot 30 as a home agent may not be made as a portable type illustrated in FIG. 8, but may be made as an immobile type.

In a case where the agent robot 30 is used as a home agent, a child uses the communication terminal 10 to preliminarily record, in the privacy-level management database 23 (FIG. 2) of the server 20, person information of a parent, such as image data of a face, voice data, and the like, and privacy-level management information that includes recorded privacy levels, and the agent robot 30 uses the privacy-level management information that has been recorded in the privacy-level management database 23 of the server 20 to make an answer to the parent instead of the child.

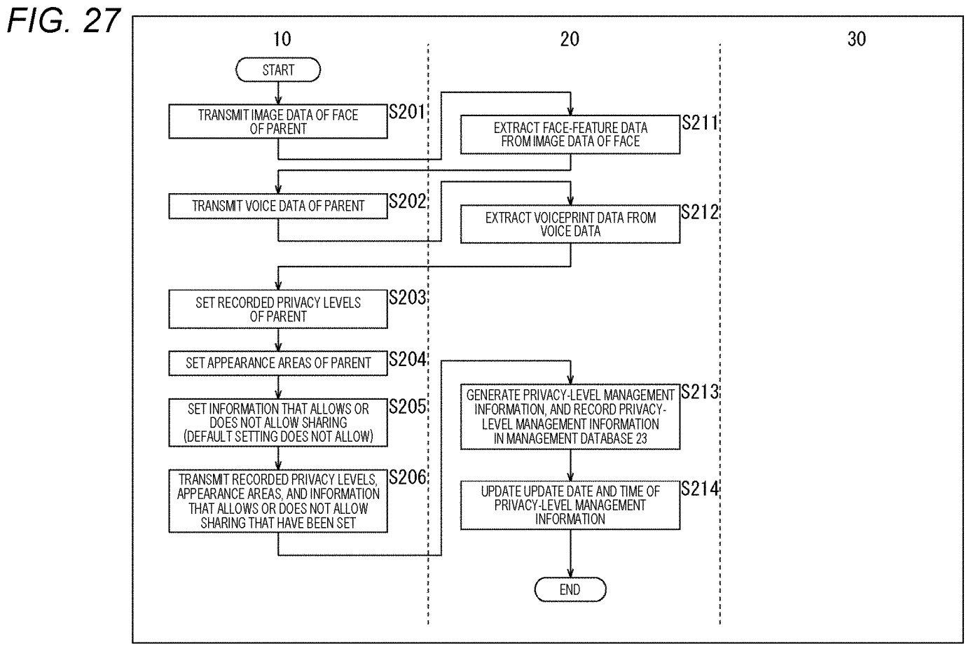

FIG. 27 is a flowchart that illustrates a process of recording privacy-level management information in a case where the agent robot 30 is used as a home agent.

In the process of recording privacy-level management information in FIG. 27, privacy-level management information (FIG. 5) is recorded in the server 20, in response to a child's operating the communication terminal 10.

After the child operates the face-picture selection button 152 in the window 150 displayed in the communication terminal 10 to record image data of a face of a parent whose recorded privacy levels are being recorded, the communication terminal 10 transmits the image data of a face of the parent to the server 20 in step S201, and the process proceeds to step S211.

In step S211, the server 20 receives the image data of a face of the parent transmitted from the communication terminal 10, and extracts face-feature data from the image data of a face of the parent, and the process proceeds to step step S202.

After the child operates the voice-file entry button 154 in the window 150 (FIG. 13) displayed in the communication terminal 10 to record voice data of the parent whose recorded privacy levels are being recorded, the communication terminal 10 transmits the voice data of the parent to the server 20 in step S202, and the process proceeds to step S212.

In step S212, the server 20 receives the voice data of the parent transmitted from the communication terminal 10, and extracts voiceprint data from the voice data of the parent, and the process proceeds to step S203.

After the child operates the buttons 157 of the conversation permitting column 156 in the window 150 (FIG. 13) displayed in the communication terminal 10, the communication terminal 10 sets recorded privacy levels of the parent according to the operation of the buttons 157 in step S203, and the process proceeds to step S204.

After the child operates the buttons 159 of the area column 158 in the window 150 (FIG. 13) displayed in the communication terminal 10, the communication terminal 10 sets appearance areas of the parent according to the operation of the buttons 159 in step S204, and the process proceeds to step S205.

In step S205, according to whether or not the checkbox 160 in the window 150 (FIG. 13) has been checked by a user of the communication terminal 10, the communication terminal 10 sets information that allows or does not allow sharing, and the process proceeds to step S206. Here, a default setting of the information that allows or does not allow sharing does not allow sharing (the checkbox 160 is not checked).

In step S206, the communication terminal 10 transmits, to the server 20, the recorded privacy levels, the appearance areas, and the information that allows or does not allow sharing that have been set in steps S203 to S205, and the process proceeds to step S213.

Note that in a case where the child enters a full name of the parent in the full-name entry column 151 in the window 150 (FIG. 13), the full name is also transmitted in step S206.

In step S213, the server 20 receives the recorded privacy levels, the appearance areas, and the information that allows or does not allow sharing, and the full name, of the parent that have been transmitted from the communication terminal 10. Moreover, to generate person information, the server 20 adds a person ID to the face-feature data and the voiceprint data that have been extracted in steps S211 and S212, and the full name of the parent from the communication terminal 10. Then, to generate privacy-level management information (FIG. 5) regarding the parent, the server 20 associates the person information with the recorded privacy levels, (area IDs that indicate) the appearance areas, and the information that allows or does not allow sharing, of the parent that are from the communication terminal 10, and a default update date and time.

The server 20 records the privacy-level management information (FIG. 5) that has been generated for the parent in the privacy-level management table (FIG. 5) of the privacy-level management database 23 in such a manner that the privacy-level management information (FIG. 5) that has been generated for the parent is added to the privacy-level management table (FIG. 5) of the privacy-level management database 23. The process proceeds from step S213 to step S214.

In step S214, the server 20 updates an update date and time of the privacy-level management information (FIG. 5) that has been recorded in the privacy-level management table (FIG. 5) to a current date and time, and the process of recording privacy-level management information is ended.

As described above, in the process of recording privacy-level management information, privacy-level management information (FIG. 5) in which recorded privacy levels and the like are associated with person information that includes face-feature data and voiceprint data of a parent is recorded in the server 20. Consequently, in a case where the parent talks to the agent robot 30, the agent robot 30 outputs an answer message in which contents are limited according to privacy levels for an answer that are set according to recorded privacy levels that have been set by a child.

Therefore, the child may set, for example, recorded privacy levels for a father and recorded privacy levels for a mother that are different from each other. Consequently, the child allows the agent robot 30 to output an answer message to the father and an answer message to the mother contents of which are different from each other.

Here, the agent robot 30 performs processes similar to the flowcharts illustrated in FIGS. 20 to 25, as a process of setting privacy levels for an answer in a case where an answer is made to the parent, and a process of an answer.

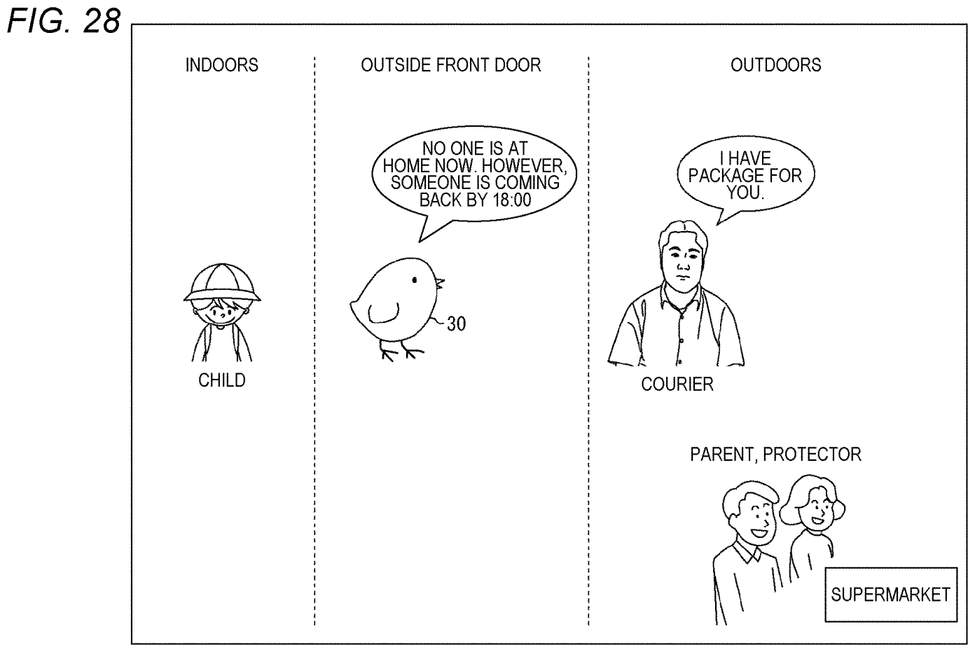

FIG. 28 is a diagram that illustrates another example of use of the agent robot 30.

FIG. 28 illustrates, for example, a situation where a courier comes home, in a situation where a child stays alone at the home since a parent has gone shopping to a supermarket.

For example, the agent robot 30 is installed as an intercom of the home. The child does not answer the intercom, but the agent robot 30 answers the courier instead of the child. For example, the agent robot 30 checks a schedule of the parent managed on the Internet, and makes an answer message that requests a redelivery according to a fact that a person to be answered is the courier, and outputs the answer message.

The agent robot 30 may also be used as what is called a smart speaker, and the like.

### 2. Explanation of Computer to which the Present Technology is Applied

Next, the series of processes of the server 20 and the information processing unit 35 that have been described above may be performed by hardware, or may be performed by software. In a case where the series of processes are performed by software, programs that constitute the software is installed in a computer.

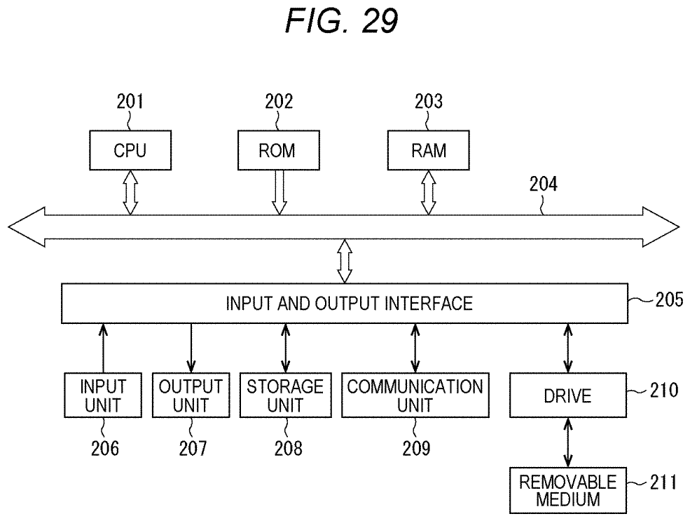

Here, FIG. 29 illustrates an example of configuration of an exemplary embodiment of a computer in which programs that perform the series of processes that have been described above are installed.

In FIG. 29, a central processing unit (CPU) 201 performs various processes according to programs stored in a read only memory (ROM) 202, or programs loaded into random access memory (RAM) 203 from a storage unit 108. Data and the like that the CPU 201 requires to perform various processes are also appropriately stored in the RAM 203.

The CPU 201, the ROM 202, and the RAM 203 are connected with each other through a bus 204. Input and output interfaces 205 are also connected with the bus 204.

Input units 206 that include a keyboard, a mouse, and the like, output units 207 that include a display that includes a liquid crystal display (LCD) or the like, a speaker, and the like, a storage unit 208 that includes a hard disk or the like, and a communication unit 209 that includes a modem, a terminal adapter, and the like are connected with the input and output interfaces 205. The communication unit 209 processes communication through networks, such as the Internet and the like.

A drive 210 is also connected with the input and output interfaces 205, as necessary. A removable medium 211, such as a magnetic disk, an optical disk, a magneto-optical disk, semiconductor memory, or the like, is appropriately loaded into the drive 210, as necessary. Computer programs read from the removable medium 211 are installed into the storage unit 208, as necessary.

Note that programs executed by the computer may be programs according to which the processes are performed in the order described in the present description in a time series, may be programs according to which the processes are performed in parallel, or may be programs according to which the processes are performed at necessary timings that are a time at which a program is called, and the like

Exemplary embodiments of the present technology are not limited to the exemplary embodiment described above, but various modifications are possible within a scope that does not depart from the spirit of the present technology.

Note that effects described in the present description are absolutely illustrative and not limitative. Other effects that are not described in the present description may be.

<Others>

The present technology may be configured as follows:

(1)

An information processing device including:

a microphone that collects a voice; and

an output unit that outputs an answer message obtained by:

setting a privacy level for an answer according to a person to be answered, the privacy level for an answer including a privacy level at a time of an answer to the person to be answered, the privacy level indicating a degree to which personal information regarding a user is disclosed; and

generating the answer message that answers an utterance of the person to be answered that has been collected with the microphone, the answer message corresponding to the privacy level for an answer.

(2)

The information processing device according to (1),

in which the output unit outputs a voice of the answer message.

(3)

The information processing device according to (1) or (2),

further including a setting part that sets the privacy level for an answer.

(4)

The information processing device according to any one of (1) to (3),

further including a generating part that generates the answer message.

(5)

The information processing device according to any one of (1) to (4),

in which the privacy level for an answer is set according to a recorded privacy level that includes the privacy level that has been recorded for the person to be answered.

(6)

The information processing device according to (5),

in which in privacy-level management information, person information regarding a person is associated with the recorded privacy level for the person who corresponds to the person information, and

the privacy level for an answer is set according to the recorded privacy level associated with the person information that matches the person to be answered in the privacy-level management information.

(7)

The information processing device according to (6),

further including a camera that captures an image,

in which the privacy level for an answer is set according to the recorded privacy level associated with the person information that matches an image feature of the person to be answered in the privacy-level management information, the image feature being obtained from the image captured with the camera.

(8)

The information processing device according to (6),

in which the privacy level for an answer is set according to the recorded privacy level associated with the person information that matches a voice feature of the person to be answered in the privacy-level management information, the voice feature being obtained from the voice collected with the microphone. (9)

The information processing device according to (5) to (8),

in which the recorded privacy level is recorded for every genre of the personal information.

(10)

The information processing device according to any one of (1) to (9),

in which the privacy level for an answer is also set according to safety information of a current location.

(11)

The information processing device according to any one of (1) to (10),

in which the privacy level for an answer is also set according to a current time.

(12)

The information processing device according to any one of (1) to (11),

in which the privacy level for an answer is also set according to a height of the person to be answered.

(13)

The information processing device according to any one of (6) to (8),

in which the person information of the privacy-level management information of the user is shared as the person information of the privacy-level management information of another user, and thus the privacy-level management information of the another user is generated.

(14)

The information processing device according to (13),

in which in the privacy-level management information, the person information is associated with the recorded privacy level, and area information that indicates an area where the person who corresponds to the person information appears, and

the person information of the privacy-level management information of the user is shared as the person information of the privacy-level management information of the another user who appears in the area indicated by the area information of the privacy-level management information of the user, and thus the privacy-level management information of the another user is generated.

(15)

The information processing device according to any one of (1) to (14),

further including a communication unit that receives the answer message from a server.

(16)

An information processing method including:

collecting a voice; and

outputting an answer message obtained by:

setting a privacy level for an answer according to a person to be answered, the privacy level for an answer including a privacy level at a time of an answer to the person to be answered, the privacy level indicating a degree to which personal information regarding a user is disclosed; and

generating the answer message that answers an utterance of the person to be answered that has been collected with the microphone.

In the answer message, disclosure of the personal information is limited according to the privacy level for an answer.

(17)

A program that allows a computer to function as an output unit that outputs an answer message obtained by:

setting a privacy level for an answer according to a person to be answered, the privacy level for an answer including a privacy level at a time of an answer to the person to be answered, the privacy level indicating a degree to which personal information regarding a user is disclosed; and

generating the answer message that answers an utterance of the person to be answered that has been collected with a microphone.

In the answer message, disclosure of the personal information is limited according to the privacy level for an answer.

### REFERENCE SIGNS LIST

10 Communication terminal
20 Server
21 Communication unit
22 User management database
23 Privacy-level management database
24 Suspicious-person management database
25 District-safety-information database
30 Agent robot
31 Camera
32 Microphone
33 Sensor unit
34 Communication unit
35 Information processing unit
36 Output unit
41 Utterance analyzing part
42 Privacy-level management database
43 Privacy-level determining engine
44 Automatically answering engine
45 Voice synthesizing part
100 Window
101 to 104 Newly-recording button
105 Recording button
110 Window
111 Recording button
120 Window
121 Recording button
130 Window
131 Recording button
132 Strict-secrecy checkbox
140 Window
141 Recording button
142 Selection box
143, 144 Entry box
150 Window
151 Full-name entry column
152 Face-picture selection button
153 Face-picture icon
154 Voice-file entry button
155 File name of voice file
156 Conversation permitting column
157 Button
158 Area column
159 Button
160 Checkbox
201 CPU
202 ROM
203 RAM
204 Bus
205 Input and output interface
206 Input unit
207 Output unit
208 Storage unit
209 Communication unit
210 Drive
211 Removable disk

1. An information processing device comprising:
a microphone that collects a voice; and
an output unit that outputs an answer message obtained by:
setting a privacy level for an answer according to a person to be answered, the privacy level for an answer including a privacy level at a time of an answer to the person to be answered, the privacy level indicating a degree to which personal information regarding a user is disclosed; and
generating the answer message that answers an utterance of the person to be answered that has been collected with the microphone, the answer message corresponding to the privacy level for an answer.

2. The information processing device according to claim 1,
wherein the output unit outputs a voice of the answer message.

3. The information processing device according to claim 1,
further comprising a setting part that sets the privacy level for an answer.

4. The information processing device according to claim 1,
further comprising a generating part that generates the answer message.

5. The information processing device according to claim 1,
wherein the privacy level for an answer is set according to a recorded privacy level that includes the privacy level that has been recorded for the person to be answered.

6. The information processing device according to claim 5,
wherein in privacy-level management information, person information regarding a person is associated with the recorded privacy level for the person who corresponds to the person information, and
the privacy level for an answer is set according to the recorded privacy level associated with the person information that matches the person to be answered in the privacy-level management information.

7. The information processing device according to claim 6,
further comprising a camera that captures an image,
wherein the privacy level for an answer is set according to the recorded privacy level associated with the person information that matches an image feature of the person to be answered in the privacy-level management information, the image feature being obtained from the image captured with the camera.

8. The information processing device according to claim 6,
wherein the privacy level for an answer is set according to the recorded privacy level associated with the person information that matches a voice feature of the person to be answered in the privacy-level management information, the voice feature being obtained from the voice collected with the microphone.

9. The information processing device according to claim 5,
wherein the recorded privacy level is recorded for every genre of the personal information.

10. The information processing device according to claim 1,
wherein the privacy level for an answer is also set according to safety information of a current location.

11. The information processing device according to claim 1,
wherein the privacy level for an answer is also set according to a current time.

12. The information processing device according to claim 1,
wherein the privacy level for an answer is also set according to a height of the person to be answered.

13. The information processing device according to claim 6,
wherein the person information of the privacy-level management information of the user is shared as the person information of the privacy-level management information of another user, and thus the privacy-level management information of the another user is generated.

14. The information processing device according to claim 13,
wherein in the privacy-level management information, the person information is associated with the recorded privacy level, and area information that indicates an area where the person who corresponds to the person information appears, and
the person information of the privacy-level management information of the user is shared as the person information of the privacy-level management information of the another user who appears in the area indicated by the area information of the privacy-level management information of the user, and thus the privacy-level management information of the another user is generated.

15. The information processing device according to claim 1,
further comprising a communication unit that receives the answer message from a server.

16. An information processing method comprising:
collecting a voice; and
outputting an answer message obtained by:
setting a privacy level for an answer according to a person to be answered, the privacy level for an answer including a privacy level at a time of an answer to the person to be answered, the privacy level indicating a degree to which personal information regarding a user is disclosed; and
generating the answer message that answers an utterance of the person to be answered that has been collected with the microphone, the answer message corresponding to the privacy level for an answer.

17. A program that allows a computer to function as
an output unit that outputs an answer message obtained by:
setting a privacy level for an answer according to a person to be answered, the privacy level for an answer including a privacy level at a time of an answer to the person to be answered, the privacy level indicating a degree to which personal information regarding a user is disclosed; and
generating the answer message that answers an utterance of the person to be answered that has been collected with a microphone, the answer message corresponding to the privacy level for an answer.
